(19) United States
(12) Patent Application Publication
(10) Pub. No.: US 2011/0221633 A1
(43) Pub. Date: Sep. 15, 2011

(54) METHODS AND SYSTEMS FOR DETERMINING THE DISTANCE BETWEEN TWO OBJECTS USING WIRELESSLY TRANSMITTED PULSES

(76) Inventors: Benjamin Bela Schramm, Los Gatos, CA (US); Bernardus Hendrik Smit, San Jose, CA (US); Oliver Peter King-Smith, Aptos, CA (US)

(21) Appl. No.: 12/722,399

(22) Filed: Mar. 11, 2010

(51) Int. Cl. G01S 1/30; G01S 1/08

(52) U.S. Cl. 342/394; 342/386; 342/387

(57) ABSTRACT

Methods and systems for determining the distance between two objects and optionally activating an alarm when the distance exceeds a predetermined threshold. The detection system includes a base unit and a remote unit. The base unit includes a first transmitter for transmitting at least one locator pulse; a first receiver for receiving at least one return pulse, the first receiver including a pulse detector for detecting the leading edge of the at least one return pulse; and a distance measurement unit. The remote unit includes a second receiver for receiving the at least one locator pulse; and a second transmitter for transmitting the at least one return pulse in response to the at least one locator pulse. The distance measurement unit is adapted for determining the distance between the base unit and the remote unit based on the leading edge of the at least one return pulse.

### FIELD

Embodiments described herein relate to methods and systems for determining the distance between two objects. In particular, the embodiments described herein relate to methods and systems for determining the distance between two objects by wirelessly transmitting pulses between the objects.

### BACKGROUND

Loss of personal possessions such as wallets, purses, laptops, cell phones, cameras and other objects of value, is a common occurrence through accident, inadvertence, or theft. For example, busy public transportation hubs such as airports, train stations and bus stations and the like, create conditions where confusingly similar articles may be taken in error, or misplaced, or stolen. According to a study of 106 major U.S. airports and 800 business travelers published by the Poneman Institute and Dell Computer, about 12,000 laptops are lost in U.S. airports each week. Only 30 percent of the travelers ever recover the lost devices. Nearly half of the travelers reported that their laptops contained customer data or confidential business information.

In recognition of the problem, short-range proximity systems have been developed to monitor the proximity of a person to an object of value. Typically, there is a base unit and a remote unit. The base unit is attached to the person and the remote unit is attached to the object of value. The base unit is configured to generate an audio and/or visual alarm when the remote unit is more than a predetermined distance away from the base unit.

In many prior art proximity systems, the remote unit transmits an RF (radio frequency) signal to the base unit. The base unit then determines the distance between the base unit and the remote unit based on the strength of the received signal. However, these systems are unreliable. Specifically, determining the distance based on signal strength presumes that the signal will always emanate at the same strength, and that it will be attenuated as a function of distance in the same manner, regardless of the physical surroundings of the area in which the system is used, the positions of the transmit and receive antennas, weather conditions and other factors which cause differences in signal attenuation.

In other prior art proximity systems the distance between the base unit and the remote unit is calculated by determining the time it takes for information to be transmitted from the base unit to the remote unit or from the remote unit to the base unit. These types of prior art proximity systems are typically referred to as time of flight proximity systems. Most of the prior art time of flight proximity systems do not appropriately account for multi-path reflections. Such multi-path reflections occur when an RF signal reflects from a nearby object. Multi-path reflections can cause attenuation and cancellation when the reflection is at the wrong location making signals appear to be arriving earlier or later than they really are.

### SUMMARY

Embodiments described herein relate to methods and systems for determining the distance between two objects and optionally activating an alarm when the distance exceeds a predetermined threshold.

In one broad aspect there is provided a detection system. The detection system includes:

a base unit including a first transmitter for transmitting at least one locator pulse; a first receiver for receiving at least one return pulse, the first receiver including a pulse detector for detecting the leading edge of the at least one return pulse; and a distance measurement unit; and

a remote unit including a second receiver for receiving the at least one locator pulse; and a second transmitter for transmitting the at least one return pulse in response to the at least one locator pulse;

wherein the distance measurement unit is adapted for determining the distance between the base unit and the remote unit based on the leading edge of the at least one return pulse.

In another feature of that aspect, at least one of the base unit and the remote unit further includes an alarm unit and the distance measurement unit activates the alarm unit when the distance exceeds a predetermined threshold.

In another feature of that aspect, the distance measurement unit determines the distance between the base unit and the remote unit by measuring the phase difference between the at least one locator pulse and the at least one return pulse.

In another feature of that aspect, the distance measurement unit includes a multiplier for combining a trigger signal and a notification signal to produce the phase difference, wherein the trigger signal is related to the at least one locator pulse and the notification signal is related to the at least one return pulse.

In another feature of that aspect, the distance measurement unit further includes a phase locked loop for locking onto the notification signal.

In another feature of that aspect, the distance measurement unit determines the distance between the base unit and the remote unit by measuring the time of flight of the at least one return pulse.

In another feature of that aspect, the distance measurement unit includes a timer for measuring the time between sending the at least one locator pulse and detecting the leading edge of the corresponding at least one return pulse. In another feature of that aspect, the timer is at least one of a time to digital converter and a time to analog converter.

In another feature of that aspect, the at least one locator pulse and the at least one return pulse are shaped to reduce the effect of multipath reflections.

In another feature of that aspect, the first transmitter generates the at least one locator pulse by combining a carrier signal and a modulation signal.

In another feature of that aspect, the first transmitter includes:

a high frequency oscillator for generating the carrier signal;

a modulation signal generator for generating the modulation signal; and

a multiplier for combining the carrier signal and the modulation signal to produce the at least one locator pulse.

In another feature of that aspect, the modulation signal is selected from one of the group comprising: a rectangle wave signal, a sinc signal, a Gaussian signal and a Gaussian derivative signal.

In another feature of that aspect, the modulation signal generator is a digital to analog converter.

In another feature of that aspect, the first transmitter generates the at least one locator pulse using a step recovery diode technique.

In another feature of that aspect, multipath reflections caused by a far object have substantially no effect on the at least one locator pulse and the at least one return pulse, wherein a far object is an object that satisfies the following equation:

x₁+x₂−d>c·t_{c}

where x₁ is the distance between the object and the base unit, x₂ is the distance between the object and the remote unit, d is the distance between the base unit and the remote unit, c is the speed of light, and t_{c} is the width of the at least one locator pulse.

In another feature of that aspect, the first receiver includes a level detector for detecting the leading edge of the at least one return pulse.

In another feature of that aspect, the first receiver further includes gain adjustment circuitry to automatically adjust the gain of the at least one return pulse based on the strength of the at least one return pulse.

In another feature of that aspect, the base unit further includes a first timer, the first timer operable to activate the first transmitter at a first predetermined time for a first predetermined period, and the first receiver at a second predetermined time for a second predetermined period; and the remote unit further includes a second timer, the second timer operable to activate the second receiver at a third predetermined time for a third predetermined period, and the second transmitter at a fourth predetermined time for a fourth predetermined period.

In another aspect of that feature, the second timer adjusts the third predetermined time based on when during the third predetermined period the locator pulse is received at the remote unit.

In another aspect of that feature, the locator pulse is received in a first portion of the third predetermined period the second timer reduces the third predetermined time, and if the locator pulse is received in a last portion of the third predetermined period the second timer increases the third predetermined time.

In another aspect of that feature, the base unit further includes a communication port which is adapted to receive the remote unit and when the remote unit is inserted in the communication port, the base unit and remote unit engage in a synchronization process, wherein the synchronization process includes establishing the predetermined times and periods.

In another broad aspect there is provided a method for determining the distance between a base unit and a remote unit. The method includes:
generating at least one locator pulse;
wirelessly transmitting the at least one locator pulse from the base unit to the remote unit;
receiving the at least one locator pulse at the remote unit;
generating at least one return pulse in response to the at least one locator pulse;
wirelessly transmitting the at least one return pulse from the remote unit to the base unit;
receiving the at least one return pulse at the base unit;
detecting the leading edge of the at least one return pulse; and
calculating the distance between the base unit and the remote unit based on the leading edge of the at least one return pulse.

In another feature of that aspect, the method further includes activating an alarm when the distance between the base unit and the remote unit exceeds a predetermined threshold.

In another feature of that aspect, calculating the distance between the base unit and the remote unit includes measuring the phase difference between the at least one locator pulse and the at least one return pulse.

In another feature of that aspect, calculating the distance between the base unit and the remote unit includes measuring the time of flight of the at least one return pulse.

In another feature of that aspect, the at least one locator pulse and the at least one return pulse are shaped to reduce the effect of multipath reflections.

In another feature of that aspect, generating the at least one locator pulse includes combining a carrier signal and a modulation signal.

In another feature of that aspect, the carrier signal is a sinusoidal signal, and the modulation signal is selected from one of the group comprising a rectangle wave signal, a sinc signal, a Gaussian signal, and a Gaussian derivative signal.

In another feature of that aspect, the at least one locator pulse is generated using a step recovery diode technique.

In another feature of that aspect, multipath reflections caused by a far object have substantially no effect on the at least one locator pulse and the at least one return pulse, wherein a far object is an object that satisfies the following equation:

x₁+x₂−d>c*t_{c}

where x₁ is the distance between the object and the base unit, x₂ is the distance between the object and the remote unit, d is the distance between the base unit and the remote unit, c is the speed of light, and t_{c} is the width of the at least one locator pulse.

In another feature of that aspect, detecting the leading edge of the at least one return pulse includes measuring the level of the at least one return pulse.

In another feature of that aspect, detecting the leading edge of the at least one return pulse further includes automatically adjusting the gain of the return pulse based on the strength of the return pulse.

In another feature of that aspect, the method further includes: activating the base unit at a first predetermined time for a first predetermined period to transmit the at least one locator pulse;

activating the base unit at a second predetermined time for a second predetermined period to receive the at least one return pulse;

activating the remote unit at a third predetermined time for a third predetermined period to receive the at least one locator pulse; and

activating the remote unit at a fourth predetermined time for a fourth predetermined period to transmit the at least one return pulse.

In another feature of that aspect, the method further includes adjusting the third predetermined time based on when during the third predetermined period the at least one locator pulse is received at the remote unit.

In another feature of that aspect, adjusting the third predetermined time includes increasing the third predetermined time if the locator pulse is received in a first portion of the third predetermined period, and decreasing the third predetermined time if the locator pulse is received in a last portion of the third predetermined period.

In another feature of that aspect, the method further includes synchronizing the base unit and the remote unit, wherein synchronizing includes establishing the predetermined times and periods.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is an exemplary illustration showing a person, an object of value, a base unit and a remote unit;

FIG. 2 is a block diagram of the base unit of FIG. 1 in accordance with at least one embodiment;

FIG. 3 is a schematic diagram illustrating near and far objects;

FIG. 4 is a block diagram of the transmitter of FIG. 2 in accordance with a first embodiment;

FIG. 5 is a graph of exemplary rectangular and sinusoidal signals generated by the transmitter of FIG. 4 in accordance with an exemplary embodiment;

FIG. 6 is a graph of exemplary locator pulses generated by the transmitter of FIG. 4;

FIG. 7 is a block diagram of an alignment module in accordance with at least one embodiment;

FIG. 8 is a block diagram of the transmitter of FIG. 2 in accordance with a second embodiment;

FIG. 9 is a graph of an exemplary locator pulse generated by the transmitter of FIG. 8;

FIG. 10 is a block diagram of the transmitter of FIG. 2 in accordance with a third embodiment;

FIG. 11 is a block diagram of the receiver of FIG. 2 in accordance with at least one embodiment;

FIG. 12 is a block diagram of the distance measurement unit of FIG. 2 in accordance with a first embodiment;

FIG. 13 is a block diagram of the distance measurement unit of FIG. 2 in accordance with a second embodiment;

FIG. 14 is a block diagram of the distance measurement unit of FIG. 2 in accordance with a third embodiment;

FIG. 15 is a block diagram of the distance measurement unit of FIG. 2 in accordance with a fourth embodiment;

FIG. 16 is a block diagram of the remote unit of FIG. 1 in accordance with at least one embodiment;

FIG. 17 is a flowchart of a method for synchronizing the base unit and the remote unit in accordance with at least one embodiment;

FIG. 18 is a flowchart of a method for correcting clock drift in accordance with at least one embodiment; and

FIG. 19 is a flowchart of a method for determining the distance between two objects in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

Embodiments described herein relate to methods and systems for determining the distance between two objects and optionally activating an alarm when the distance exceeds a predetermined threshold.

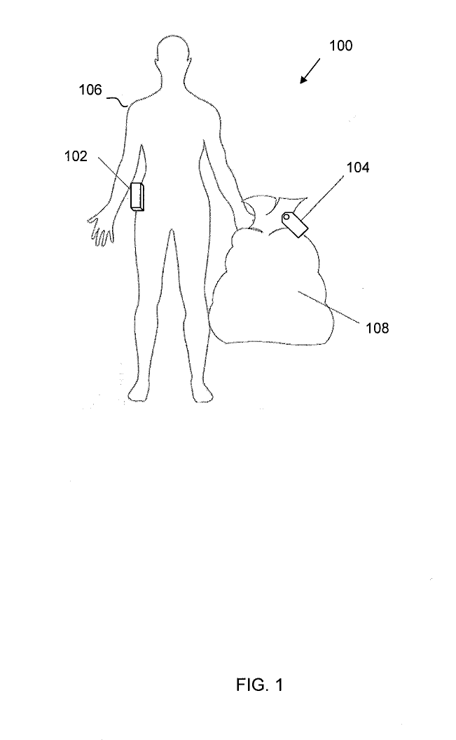

Reference is first made to FIG. 1, which illustrates a system 100 for determining the distance between two objects in accordance with an embodiment. The system 100 comprises a base unit 102 and one or more remote units 104. The base unit 102 is preferably attached to, or carried by, a person 106. The remote unit 104 is attached or otherwise maintained in proximity to an object of value 108. The remote unit 104 may be permanently affixed to the object of value 108 or it may be attached in a way that it may be removed. For example, the remote unit 104 may be attached to the object of value 108 by an adhesive, clip or other similar mechanisms.

The object of value 108 may be any item that is of value to the person 106 and need not be an object that has a minimum monetary value. For example, the object of value 108 may be a stationary object such as a cell phone, a wallet, a purse, a laptop, a musical instrument or the like; or a mobile object such as a person, child or pet.

The base unit 102 wirelessly monitors the distance between the base unit 102 (and thus in this embodiment the person 106) and the remote unit 104 (and thus the object of value 108). In some embodiments, if the distance between the base unit 102 and the remote unit 104 exceeds a predetermined distance, an alarm is activated.

Although for clarity, the embodiment shown in FIG. 1 includes only one remote unit 104, a single base unit 102 may monitor multiple remote units 104 simultaneously. In one embodiment, a single base unit 102 may monitor up to four remote units 104 concurrently.

The base unit 102 and the remote unit 104 are preferably battery-operated so that they can be used in various locations regardless of whether there are power outlets available. In some embodiments, the base and remote units 102 and 104 each have an on/off switch (not shown) to conserve battery power when not in use. In other embodiments, only the base unit 102 has an on/off switch and the remote unit 104 can only be disabled or deactivated when plugged into the base unit 102.

The base and remote units 102 and 104 may include complementary communication ports (not shown) that enable the remote unit 104 to be plugged into the base unit 102. While the remote unit 104 is plugged into the base unit 102 via the communication ports, it may be charged, synchronized, calibrated, and/or deactivated.

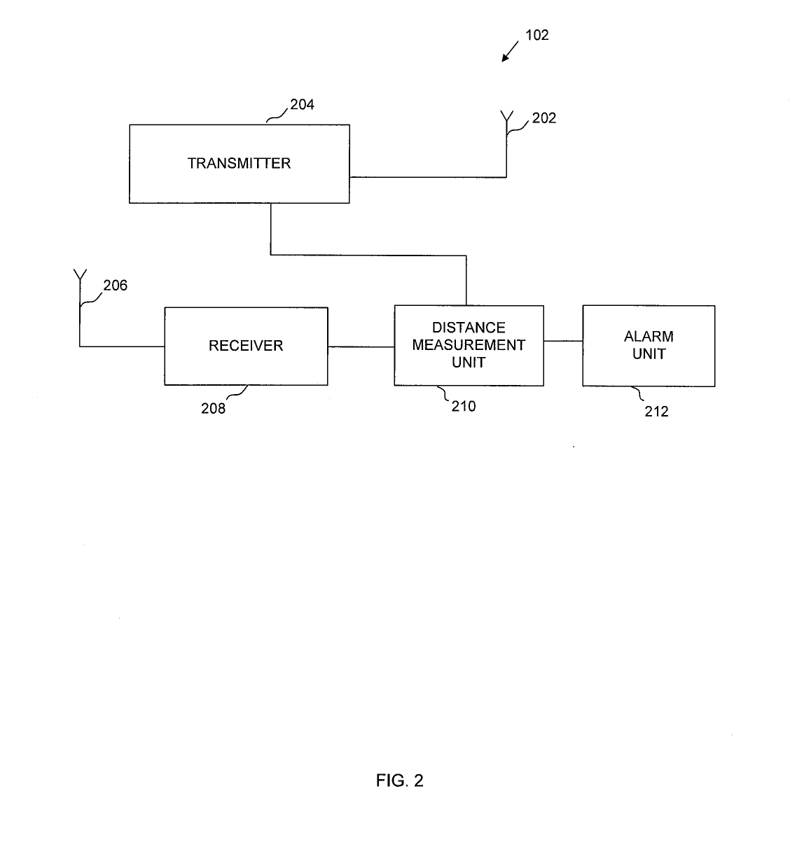

Reference is now made to FIG. 2, which illustrates a block diagram of a base unit 102 in accordance with an embodiment. The base unit 102 includes a transmitter antenna 202, a transmitter 204, a receiver antenna 206, a receiver 208, a distance measurement unit 210 and an alarm unit 212.

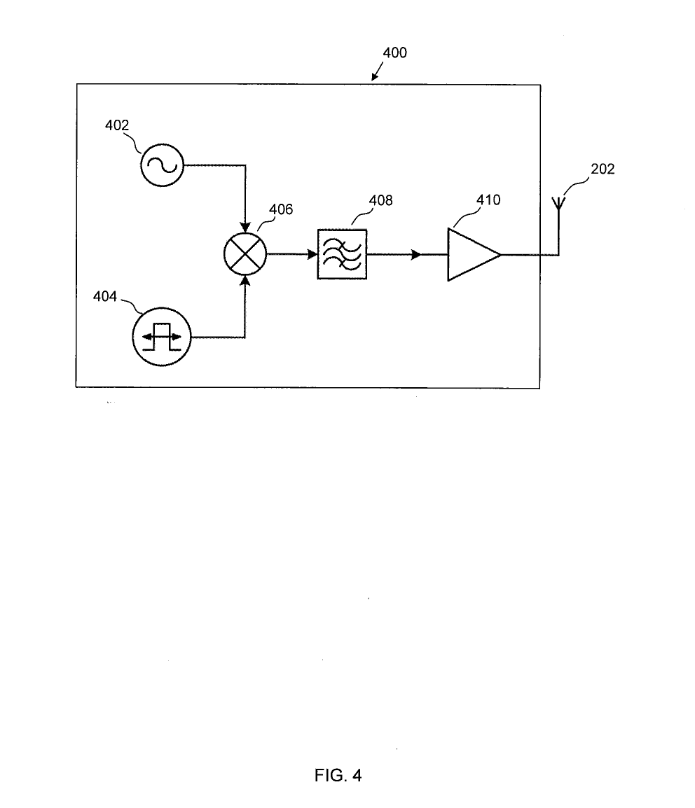

The transmitter 204, also referred to as the pulse generation unit, generates one or more RF (radio frequency) locator pulses and sends the locator pulses to the transmitter antenna 202 for transmission to the remote unit 104. Exemplary transmitters 204 will be described with reference to FIGS. 4 to 10.

Most RF transmissions are susceptible to multi-path reflections which occur when an RF signal bounces off a reflective object. In the UWB (ultra wide band) frequency range, most objects will reflect at least some of the energy in the signal. Multi-path reflections can make signals appear to be arriving earlier or later than they ought to. Specifically, a reflector (the object causing the reflection) introduces a longer path length for the RF signal to propagate and the difference between the reflected path and the direct path (i.e. the line of sight path) produces a phase shift between the two signals which may manifest itself as either destructive or constructive interference. Depending on the RF signal, the interference can cause the signal to appear to arrive earlier or later than it actually did, making the object appear closer or further away than it actually is.

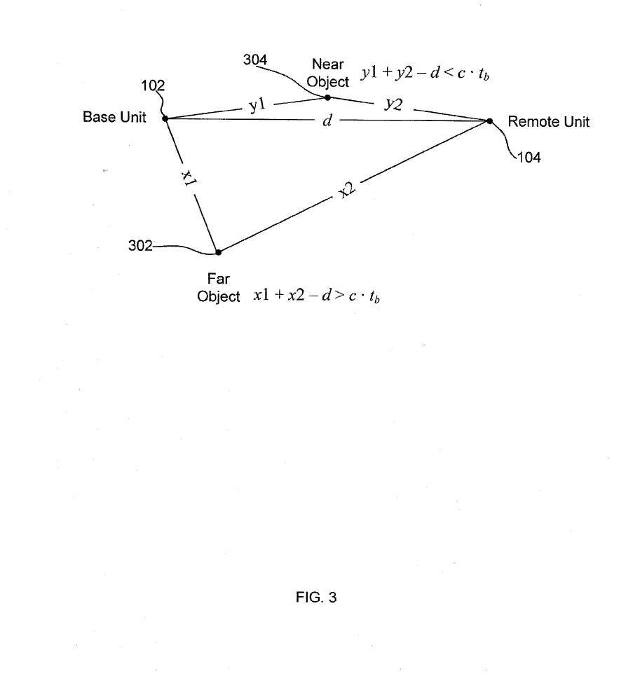

However, very short pulses are not affected by reflections caused by “far objects”. “Far objects” are opposite to “near objects”. Reference is now made to FIG. 3, which illustrates a “far object” 302 and a “near object” 304.

A “far object” 302 is defined as an object where the reflection signal path caused by the “far object” 302 is greater than the line of sight signal path by more than the pulse length. This may be expressed using equation (1), where t_{b} is the duration of the pulse, c is the speed of light (3×10⁸ m/s), d is the shortest distance (also referred to as the line of sight distance) between the base unit 102 and the remote unit 104, x₁ is the shortest distance between the base unit 102 and the “far object” 302, and x₂ is the shortest distance between the remote unit 104 and the “far object” 302:

x₁+x₂−d>c·t_{b} (1)

A “near object” 304 is defined as an object where the reflection signal path caused by the “near object” 304 is greater than the line of sight signal path by less than the pulse length. This may be expressed using equation (2) where t_{b} is the duration of the pulse, c is the speed of light (3×10⁸ m/s), d is the shortest distance (also referred to as the line of sight distance) between the base unit 102 and the remote unit 104, y₁ is the shortest distance between the base unit 102 and the “near object” 304, and y₂ is the shortest distance between the remote unit 104 and the “near object” 304:

y₁+y₂−d<c·t_{b} (2)

It can be seen from FIG. 3 that the reflection signal path length (x₁+x₂; or y₁+y₂) is related to the shortest distance between the object and the line of sight path (i.e. the perpendicular distance). Generally, the closer the object is to the line of sight, the shorter the reflection signal path. Accordingly, the closer the object is to the line of sight path, the more likely the object is a “near object” 304, and less likely the object is a “far object” 302.

Reflections caused by “far objects” 302 do not affect the detection of a short pulse because a pulse transmitted from the base unit 102 to the remote unit 104 via line of sight has already arrived at the remote unit 104 by the time any “far object” reflections arrive at the remote unit 104. Accordingly, the remote unit 104 can easily determine that the first pulse is the correct pulse and the remote unit 104 may ignore any subsequent pulses.

For example, if the pulse duration is 2 ns, the pulse length (or width) is 60 cm. Therefore, an object that has a reflection signal path that is greater than the line of site path by at least 60 cm will not cause distortions to the locator pulses.

Generally, the shorter the pulse duration, the closer an object can be to the line of sight path without causing distortions. However, there is practical limit as to how short the pulse duration can be. Specifically, as the pulse duration decreases, the bandwidth of the pulse increases. If too short a pulse duration is selected, attenuation, component selection, and licensing restrictions become problematic. For example, for “far objects” to include objects that have a reflection path that is at least 3 cm longer than the line of sight path, the pulse duration would have to be 100 ps. This pulse duration would generate RF energy in the 10 GHz range.

Accordingly, preferably, the locator pulses have a large bandwidth and a short duration. In one embodiment, the locator pulses are ultra wideband (UWB) pulses.

The remote unit 104 receives the locator pulses generated by the base unit 102 and generates and transmits one or more return pulses in response. A return pulse is defined herein as a pulse that is generated by the remote unit 104 in response to receiving a locator pulse from the base unit 102. The return pulses are typically generated in the same manner as the locator pulses.

The return pulses are received by the receiver antenna 206 which sends them to the receiver 208 for processing. The receiver 208, also referred to as the pulse detection unit, receives the return pulses and detects the leading edges of the return pulses. By detecting the leading edge of the return pulses, the number of reflectors that may affect the detection of the return pulses is reduced. Specifically, detecting the leading edge further reduces the “near objects” that may cause interference.

By focusing on the leading edge of the return pulse, the pulse detection unit or receiver 208 does not need the entire return pulse for detection. Accordingly, the length of the reflection path may no longer have to be greater than the line of sight path by more than the pulse length for an object to have no effect on the return pulse. The difference between the two paths just has to be greater than the portion of the pulse that is required for detection. Therefore, the faster the leading edge is detected, the closer an object can be to the line of sight without having any effect on the pulse detection.

In some embodiments, the pulse detection unit or receiver 208 needs no more than one quarter of a wavelength of the transmit frequency to detect the return pulses. Therefore, for example, if the return pulse is generated with a 4 GHz transmit frequency, a “near object” more than 2 cm away from the line of sight path should no longer interfere with the distance measurement.

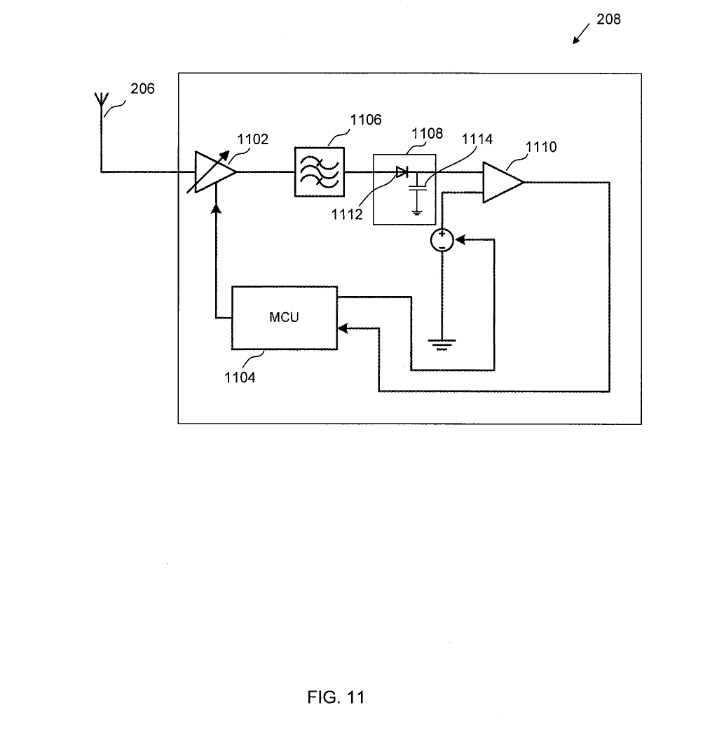

In some embodiments, the leading edges of the return pulses are detected by comparing the amplitude of the return pulses against a predetermined threshold. An exemplary receiver 208 will be described with reference to FIG. 11.

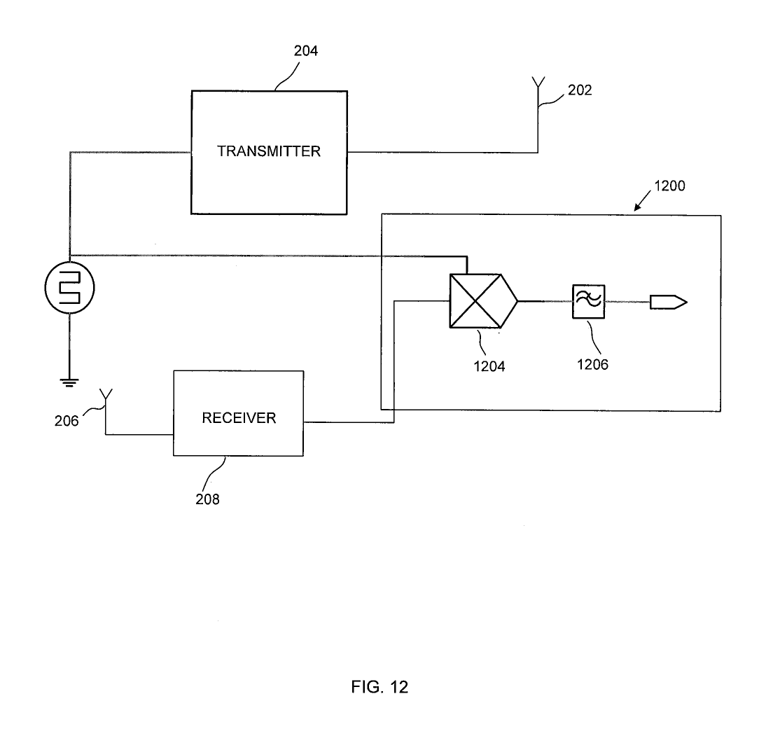

The distance measurement unit 210 receives the leading edge information from the receiver 208 and uses this information to determine the distance between the base unit 102 and the remote unit 104. In one embodiment, the distance measurement unit 210 determines the distance between the base unit 102 and the remote unit 104 based on the phase difference between the locator pulses and the return pulses. In another embodiment, the distance measurement unit 210 determines the distance between the base unit 102 and the remote unit 104 by measuring the time between sending a locator pulse and receiving a corresponding return pulse. Exemplary distance measurement units 210 will be described with reference to FIGS. 12 to 15.

In some embodiments, after determining the distance between the remote unit 104 and the base unit 102, the distance measurement unit 210 determines whether the distance exceeds a predetermined threshold and if so activates the alarm unit 212. In some embodiments the alarm unit 212 may include a visual alarm, such as an LED (light emitting diode) indicator, or an LCD (liquid crystal display) display. In other embodiments, the alarm unit 212 may include an audio alarm, such as an audio message or alert. In still other embodiments, the alarm unit 212 may include a combination of audio alarms, visual alarms, and other alarm indicators, such as shock, vibration, or heat.

Although, the transmitter antenna 202 and the receiver antenna 206 are shown in FIG. 2 as separate and distinct antennas, it will be evident to a person of a skill in the art that the base unit 102 may be implemented with a single antenna that is switched between being a transmitter antenna and a receiver antenna via an RF switch (not shown) or the like.

Reference is now made to FIG. 4, which illustrates a first embodiment 400 of the transmitter 204 of FIG. 2. As described above, the transmitter of the first embodiment 400 generates one or more locator pulses which are transmitted to the remote unit 104 via the transmitter antenna 202. In the embodiment shown in FIG. 4, the locator pulses are generated by combining a carrier signal, such as sinusoidal signal, with an analog generated modulation signal, such as a rectangular signal. The transmitter 400 includes an oscillator 402, a modulation signal generator 404, a multiplier 406, a bandpass filter 408, and an amplifier 410.

The oscillator 402 is a high frequency oscillator that generates a sinusoidal signal, such as a sine signal or a cosine signal. In some embodiments, the oscillator 402 generates a sinusoidal signal with a frequency between 3.1 GHz and 10.6 GHz. The sinusoidal signal is often referred to as the carrier signal.

The modulation signal generator 404 generates a modulation signal, such as a rectangular signal using analog techniques. In some embodiments, the modulation signal generator 404 is triggered by an external control signal, such as a clock signal. The control signal may be generated by a central micro-controller or by a separate and distinct trigger unit.

The multiplier 406 modulates the modulation signal (i.e. rectangular signal) onto the carrier or sinusoidal signal. Specifically, the multiplier 406 receives the carrier or sinusoidal signal and the modulation signal and multiplies them together to form one or more locator pulses. The multiplier 406 may be implemented using analog or digital circuitry. For example, the multiplier 406 may be implemented using a Gilbert cell, a doubly balanced mixer, or an AND gate.

The bandpass filter 408 receives the one or more locator pulses generated by the multiplier 406 and filters the one or more locator pulses to generate one or more filtered pulses. Where the multiplier 406 is implemented using digital circuitry, the one or more pulses include high and low frequency components which are not desired. The bandpass filter 408 works to remove these unwanted frequencies from the series of pulses. The bandpass filter 408 is preferably implemented using analog circuitry.

The amplifier 410 receives the one or more filtered pulses from the bandpass filter 408 and amplifies the one or more filtered pulses to a predetermined level to be transmitted by the transmitter antenna 202. For example, in one embodiment, the filtered pulses are amplified by amplifier 410 so that the transmitted power is −5 dBm EIRP (Effective Isotropically Radiated Power). The amplifier 410 may be implemented using analog components. In some embodiments, the bandpass filter 408 and the amplifier 410 are implemented in a single device. In other embodiments, such as the embodiment shown in FIG. 4, the bandpass filter 408 and the amplifier 410 are separate and distinct devices.

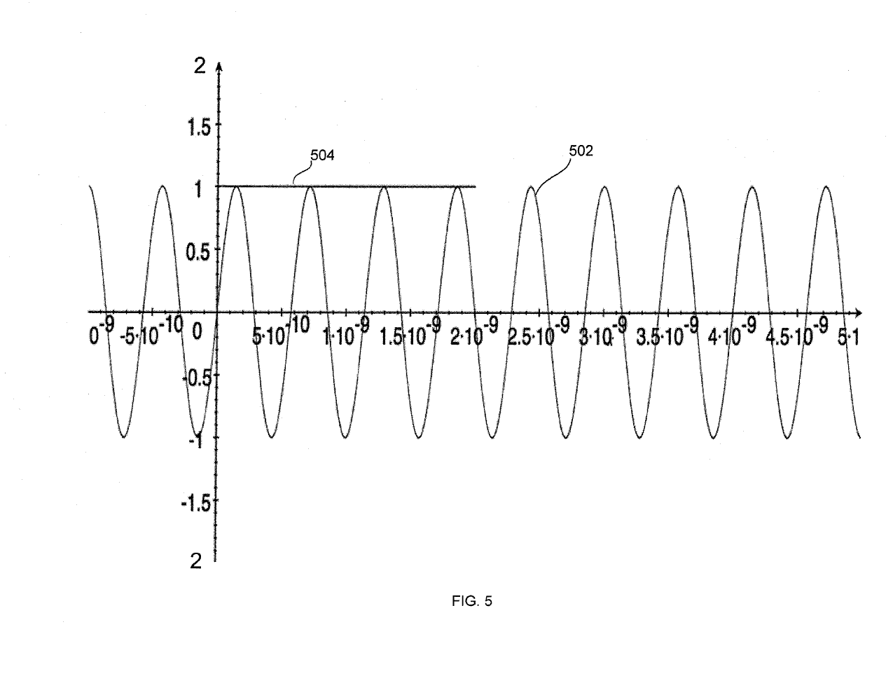

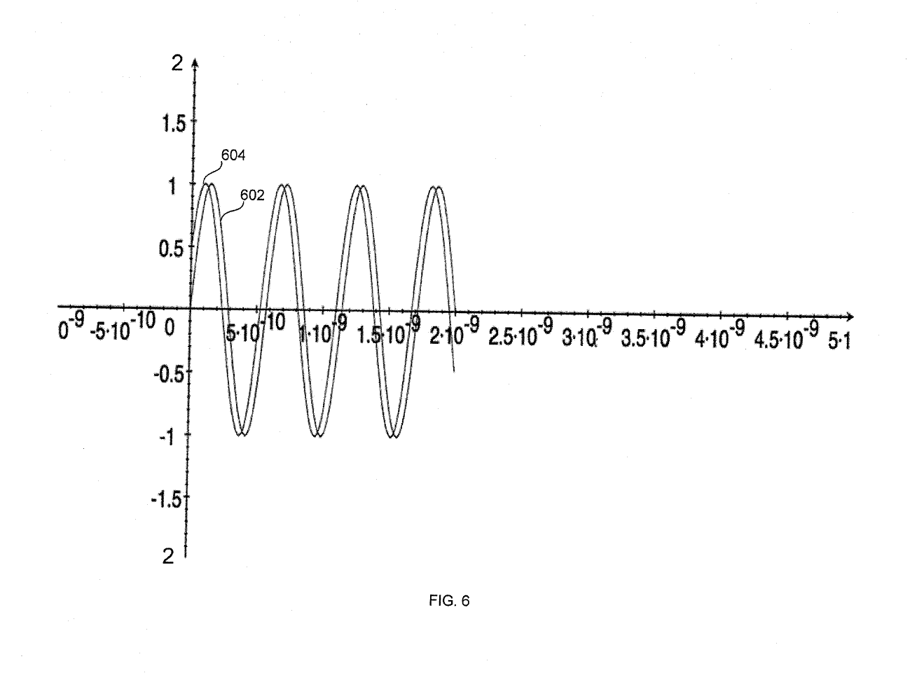

Reference is now made to FIGS. 5 and 6, which illustrate exemplary versions of the signals used and/or produced by the transmitter of the first embodiment 400 of FIG. 4. Specifically, FIG. 5 illustrates an exemplary sinusoidal signal 502 that has a frequency of 3.5 GHz, and an exemplary rectangular signal 504 that has a 2 ns pulse width.

FIG. 6 illustrates two exemplary locator pulses 602 and 604 generated by combining the sinusoidal signal 502 and the rectangular signal 504 of FIG. 5. The first exemplary locator pulse 602 illustrates the case where the rectangular signal and the sinusoidal signal are aligned. Specifically, the rising edge of the rectangular signal is aligned with the zero point (or zero crossing) of the sine wave. The second exemplary locator pulse 604 illustrates the case where the rectangular signal and the sinusoidal signal are not aligned or are misaligned.

If the carrier signal (i.e. sinusoidal signal) and the modulation signal (i.e. rectangle signal) are not aligned, the carrier signal (i.e. sinusoidal signal) may wander and the RF pulse shape generated by the combination of the sinusoidal signal and the modulation signal may vary from pulse to pulse. For example, in one pulse the carrier signal and the leading edge of the modulation signal may line up so that the leading edge hits the carrier at the zero point (or zero crossing). In a subsequent pulse the carrier signal's phase may have wandered so the leading edge of the modulation signal now hits the crest of the sinusoidal carrier. This may introduce some measurement jitter since the detected envelope of the RF pulse will vary from pulse to pulse.

Accordingly, in some embodiments, the transmitter 204 (i.e. transmitter 400) may include an alignment module that locks the leading edge of the modulation signal to a specific point of the carrier signal. Such an alignment module ensures that similar pulse shapes will be produced each time the carrier signal and the modulation signal are combined. Using an alignment module also typically produces pulses with sharper leading edges, which assists the receiver 208 in pulse detection. In some embodiments, the alignment module implements a phase-locked loop (PLL).

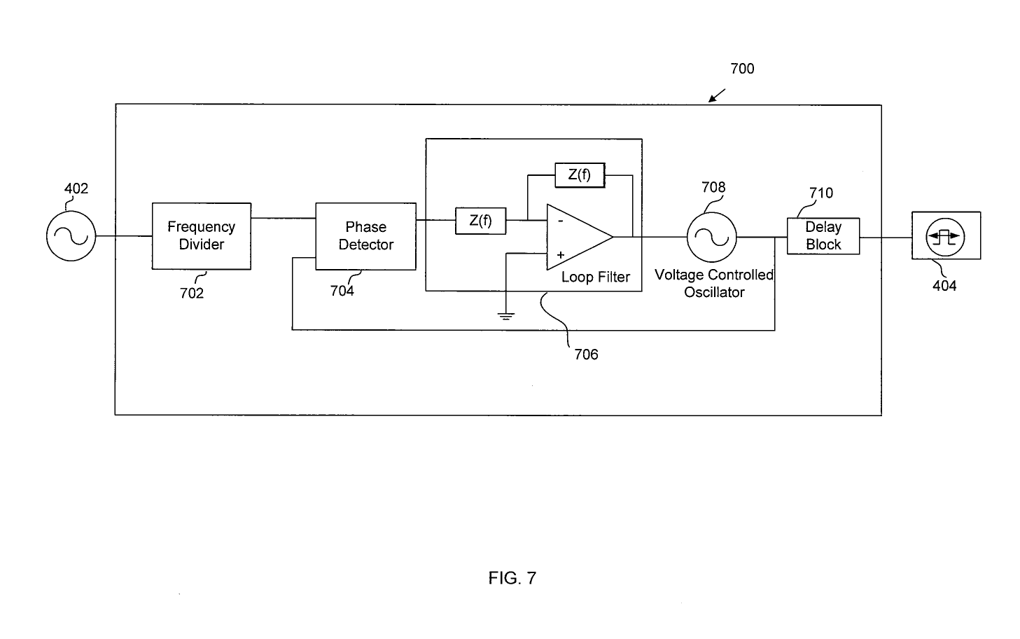

Reference is now made to FIG. 7, which illustrates an alignment module 700 in accordance with an embodiment. The alignment module 700 described in FIG. 7 implements a phase-locked loop (PLL) to lock the leading edge of the modulation signal to a specific point of the carrier signal. The alignment module 700 receives the carrier signal generated by the main oscillator (i.e. oscillator 402) and generates a trigger signal. The trigger signal is used to trigger the main modulation signal generator (i.e. modulation signal generator 404). In some embodiments, the trigger signal is a square wave with a frequency that is an integer multiple of the oscillator frequency.

The alignment module 700 includes a frequency divider 702, a phase detector 704, a loop filter 706, a voltage controlled oscillator 708, and a delay block 710. As is known to those of skill in the art, the frequency divider 702 takes the input signal (the oscillator output) with a frequency f₁, and generates an output signal with a frequency f₁/n where n is an integer. In other words, the frequency of the input signal (the oscillator output) is divided by n to generate a signal with a lower frequency. In some embodiments, the alignment module 700 is designed to produce an output signal with a frequency of 10 MHz.

In some embodiments, the frequency divider 702 includes multiple frequency dividers. Specifically, the division may be broken up into multiple phases to simplify the electronics. For example, if the input signal (the output of the oscillator) has a frequency of 3.5 GHz, it may first be divided by 5, then 7 and then 10 to produce an output signal with a frequency of 10 MHz.

The phase detector 704 compares the output of the voltage controlled oscillator 708 and the output of the frequency divider 702 and outputs a voltage signal which represents the difference in phase between the two signals. In one embodiment, the phase detector 704 is implemented using a push pull current source, known as a Type II Phase Detector. If a Type II Phase Detector is used, the phase of the output of voltage controlled oscillator 708 can be precisely kept in sync with the phase of the output of the frequency divider 702.

The loop filter 706 receives the output of the phase detector 704 and converts this input to a control voltage that is used to bias the voltage controlled oscillator 708. In some embodiments, the loop filter 706 is implemented using a simple RC network. In other embodiments, the loop filter 706 may be implemented using a more complex design involving operational amplifiers.

The voltage controlled oscillator 708 receives the control voltage from the loop filter 706 and generates a signal having a frequency that is based on the control voltage. More specifically, the frequency of oscillation is varied by the applied voltage.

The delay block 710 is optional and allows the voltage controlled oscillator output 708 to be aligned with a particular part of the carrier signal generated by the main oscillator (i.e. oscillator 402). For example, the output of the voltage controlled oscillator 708 may be aligned with the maximums in the signal generated by the oscillator (i.e. oscillator 402). The delay block 710 allows the output of the voltage controlled oscillator 708 to be adjusted to align with another part of the signal generated by the main oscillator (i.e. oscillator 402), such as the zero points (or zero crossings).

In some embodiments, the delay block 710 may be designed to implement a fixed delay. For example, the delay block 710 may be implemented by a circuit trace or transmission line. In other embodiments, the delay block 710 may be designed to implement a variable delay. A variable delay may be implemented using analog or digital circuitry using techniques known to those of skill in the art.

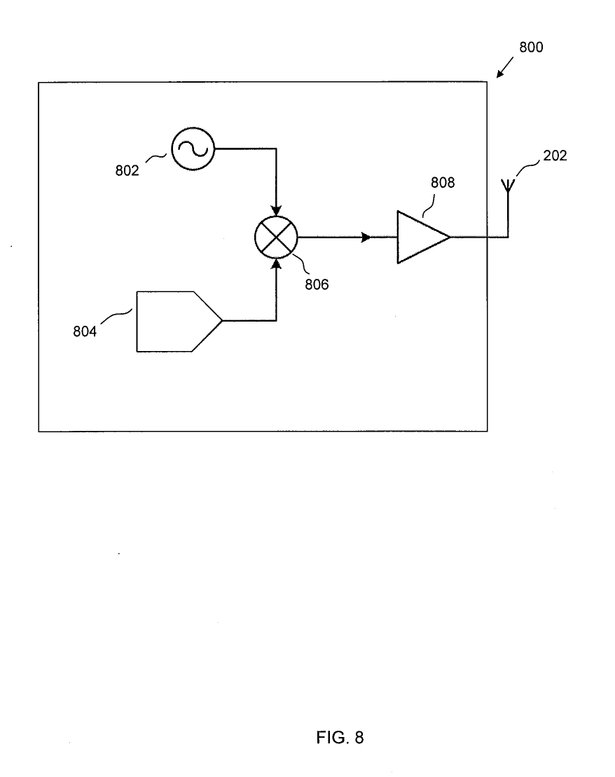

Reference is now made to FIG. 8, which illustrates a second embodiment 800 of the transmitter 204 of FIG. 2. The transmitter of the second embodiment 800 generates one or more locator pulses which are transmitted to the remote unit 104 via the transmitter antenna 202. In the embodiment shown in FIG. 8, the pulses are generated by combining a carrier signal with a digitally generated modulation signal.

The transmitter 800 includes an oscillator 802, a modulation signal generator 804, a multiplier 806, and an amplifier 808.

The oscillator 802, similar to the oscillator 402 of FIG. 4, is a high frequency oscillator that generates the carrier signal. The carrier signal is preferably a sinusoidal signal, such as a sine signal or a cosine signal. In some embodiments, the oscillator 802 generates a sinusoidal signal with a frequency between 3.1 GHz and 10.6 GHz.

The modulation signal generator 804 digitally generates the modulation signal. The modulation signal is typically generated over a short window. For example, in some embodiments the modulation signal generator 804 may generate a sinc signal with a frequency of 500 MHz over an 8 ns window. In other embodiments, the modulation signal generator 804 may generate a Gaussian signal or a Gaussian derivative signal. In some embodiments, the modulation signal generator 804 is a digital to analog converter (DAC) that approximates a sinc signal, a Gaussian signal, or a Gaussian derivative signal.

The multiplier 806 modulates the modulation signal onto the carrier signal. Specifically, the multiplier 806 receives the carrier signal and the modulation signal and multiplies them together to form one or more locator pulses. The multiplier 806 may be implemented using analog circuitry. For example, the multiplier 806 may be implemented using a Gilbert Cell Mixer.

The amplifier 808 receives the locator pulses from the multiplier 806 and amplifies the locator pulses to a predetermined level to be transmitted by the transmitter antenna 202. The amplifier 808 is preferably implemented using analog circuitry.

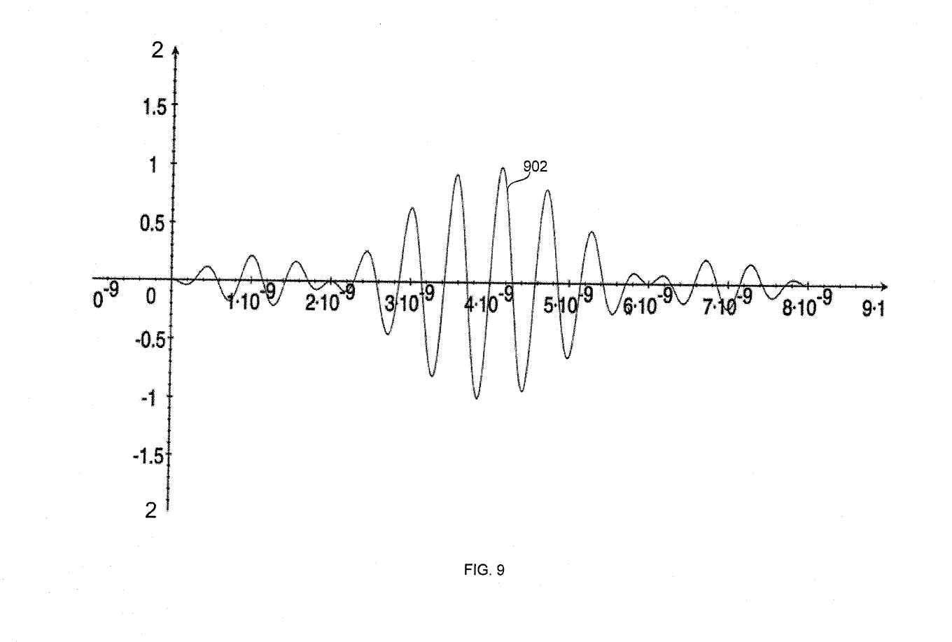

Reference is now made to FIG. 9, which illustrates an exemplary locator pulse 902 generated by the transmitter 800 of FIG. 8 when the modulation signal is a sinc signal.

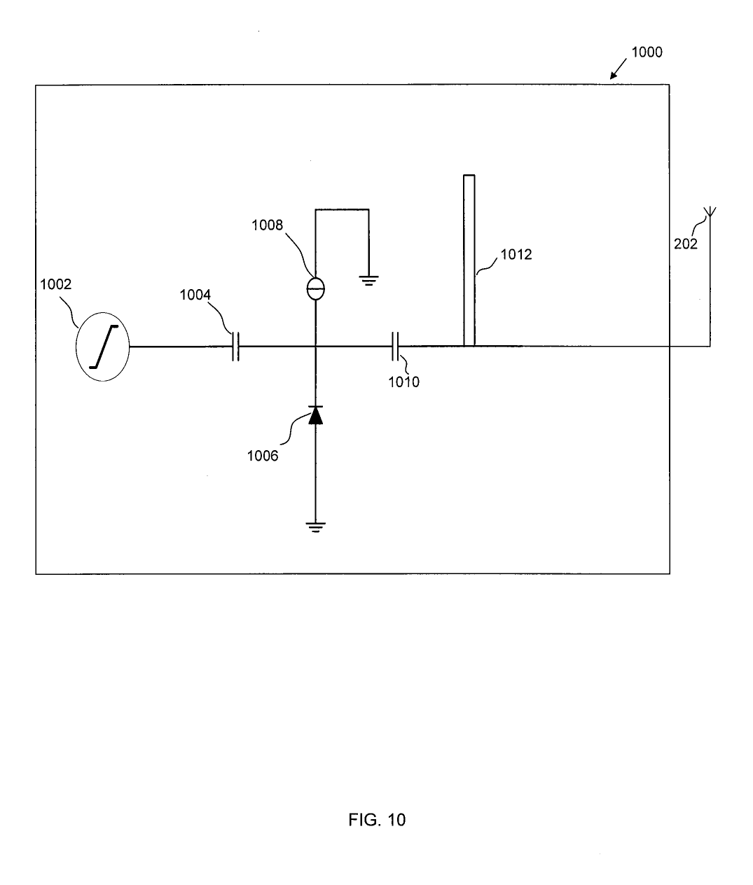

Reference is now made to FIG. 10, which illustrates a third embodiment 1000 of the transmitter 204 of FIG. 2. The transmitter of the third embodiment 1000 generates one or more locator pulses which are transmitted to the remote unit 104 via the transmitter antenna 202. In the embodiment shown in FIG. 10, the locator pulses are generated using a step recovery diode technique. The transmitter 1000 includes a step function generator 1002, a first capacitor 1004, a diode 1006, a current source 1008, a second capacitor 1010 and a transmission line 1012.

The step function generator 1002 generates a step function signal. As is known to those of skill in the art, a step function is a function that has different constant values over adjacent subintervals. Thus, it has discontinuities at the ends of each interval. The system 100 described herein does not require that the step function signal have sharp edges, therefore the step function generator 1002 may be implemented by a micro-controller unit (MCU) or a general purpose input output (GPIO) pin.

The first capacitor 1004 appears as low impedance to the step function signal produced by the step function generator 1002.

Before the step function signal produced by the step function generator 1002 is applied to the diode 1006, the diode 1006 is forward biased to a predetermined voltage (e.g. −0.7 V) by the current source 1008. The diode 1006 may be implemented, for example, using a ping diode or a step recovery diode.

The diode 1006 tries to maintain the forward bias with its stored charge, until it reverses biases quickly. This causes a rapid rise in the voltage which propagates through the second capacitor 1010. This causes a very sharp edge signal to be presented to the transmission line 1012. The very sharp edge signal is reflected back by the transmission line 1012 and when the reflection combines with the original signal produced by the second capacitor 1010, the result is a short pulse. The short pulse is then supplied to the transmitter antenna 202 to be transmitted to the remote unit 104. The edges of the pulse rise and fall quickly. The width of the pulse is determined by the length of the transmission line 1012.

The third embodiment 1000 of the transmitter 204 of FIG. 2 provides several advantages over the first and second embodiments 400 and 800 described herein. Specifically, the third embodiment 1000 may produce short and sharply defined pulses with simple electronics. This makes detection of the leading edge by the receiver 208 simpler and faster. In addition, if the generated pulses are very short (i.e. 300 ps or less) the pulses can be directly provided to the transmitter antenna 202 without being first mixed with a carrier signal (as is done in the first and second embodiments 400 and 800). However, where the generated pulses are not very short (i.e. 300 ps or less), the generated pulses may be first combined with a carrier signal prior to being provided to the transmitter antenna 202. In these embodiments, the transmitter 1000 may also include an oscillator (not shown) and a mulitiplier (not shown).

Reference is now made to FIG. 11, which illustrates in more detail a receiver 208 (shown in FIG. 2) in accordance with an embodiment. The receiver 208 receives the signals picked up by the receiver antenna 206 and analyzes the signals to determine if a response pulse was received. Specifically, the receiver 208 detects whether a leading edge of a response pulse was received. The receiver 208 includes a variable gain amplifier 1102, a micro-controller 1104, a bandpass filter 1106, a rectification circuit 1108, and a level detector 1110.

Typically the signal received by the receiver antenna 206 has a variable signal strength. For example, in some test environments, the signal attenuation varied by more than 60 dB. This variation can negatively impact the leading edge detection. Specifically, the level detector 1110, which detects the leading edge of the pulse, is amplitude sensitive. So if the received signal is weak (i.e. low amplitude), it typically takes longer for the received signal to reach an amplitude that will trigger the level detector 1110. Conversely, if the received signal is strong (i.e. high amplitude), it typically takes less time for the received signal to reach an amplitude that will trigger the level detector 1110. Accordingly, the inventors have discovered that the receiver 208 typically generates more reproducible results if the received signal amplitude is adjusted to provide consistent amplitude to the level detector 1110.

As a result, in some embodiments, the receiver 208 may include a variable gain amplifier 1102 to ensure that the incoming signal is consistently processed with substantially the same amplitude. Specifically, the variable gain amplifier 1102 adjusts the gain applied to the signal based on the strength of the received signal.

In the embodiment shown in FIG. 11, the variable gain amplifier 1102 is digitally controlled by a micro-controller 1104. However, it will be evident to persons of skill in the art that other techniques may be used to control the gain of the variable gain amplifier 1102.

While the variable gain amplifier 1102 is an optional component in the receiver 208, the inventors have discovered that where the gain of the incoming signal is not adjusted using, for example, a variable gain amplifier 1102, the components in the system, such as the level detector 1110, may become saturated. Specifically, in a high dynamic range system, such as the system described herein, the high gains can cause the components (i.e. the level detector 1110) to saturate if there are any nearby low power RF sources. Saturating the components in the receiver 208 typically masks out the received signal (i.e. the return pulse) making it difficult to detect.

The bandpass filter 1106 receives the amplified signal generated by the variable gain amplifier 1102 and filters the amplified signal to produce a filtered signal. The bandpass filter 1106 is designed to remove frequencies outside of the expected range. Generally, the bandpass filter 1106 removes frequencies that fall outside the band of the return pulses. In some embodiments, the return pulses reside within the 3.1 to 10.6 GHz range. Accordingly, in these embodiments, the bandpass filter 1106 would remove frequencies outside of the 3.1 to 10.6 GHz range. In other embodiments, the return pulses reside within the 3.1 to 6 GHz range. Accordingly, in these embodiments, the bandpass filter 1106 would remove frequencies outside of the 3.1 to 6 GHz range. In the embodiment shown in FIG. 11, the bandpass filter 1106 is shown as a separate and distinct component, however, in other embodiments the filtering may be implemented by other components, such as the receiver antenna 206, and/or in various amplifier stages.

The rectification circuit 1108 receives the filtered signal from the bandpass filter 1106 and rectifies the filtered signal to produce a rectified signal. As is known to persons of skill in the art, rectification is the process of converting an AC signal into a DC signal. The rectification process effectively demodulates the modulation signal (e.g. the original rectangular signal, sinc signal, or Gaussian signal) from the carrier signal. The rectification circuit 1108 may be implemented using analog or digital circuitry, or a combination of the two. In one embodiment, the rectification circuit 1108 may be implemented by a diode 1112 and a filtering capacitor 1114.

In another embodiment, the rectification circuit 1108 may be implemented by a multiplier (not shown) and a low pass filter (not shown). The multiplier is used to multiply the filtered signal with itself. This produces a signal with two components—a DC component that represents the original modulation signal (e.g. the original rectangular signal, sinc signal or Gaussian signal); and a high frequency component that represents the original modulation signal modulated on a carrier wave that is double the frequency of the original carrier wave. This signal is passed through the low pass filter to remove the high frequency component. This leaves a baseband copy of the original modulation signal (e.g. the original. rectangular signal, sinc signal or Gaussian signal). However, it will be evident to persons of skill in the art that the rectification circuit 1108 may be implemented using other components or techniques, or both.

The level detector 1110 receives the rectified signal produced by the rectification circuit 1108, and a reference signal selected by the micro-controller 1104, and determines if the amplitude of the rectified signal exceeds the amplitude of the reference signal. If the amplitude of the rectified signal is determined to exceed the amplitude of the reference signal, then a notification pulse is generated and sent to the distance measurement unit 210. The level detector 1110 may be implemented using analog or digital circuitry. For example, the level detector 1110 may be implemented using an analog to digital converter (ADC) or a comparator.

Reference is now made to FIG. 12, which illustrates a first embodiment 1200 of the distance measurement unit 210 of FIG. 2. As described above, the first embodiment 1200 of the distance measurement unit 210 determines the distance between the base unit 102 (and thus the person 106) and the remote unit 104 (and thus the object of value 108). In some cases, if the distance exceeds a predetermined threshold, the distance measurement unit 1200 activates the alarm unit 212. In the embodiment shown in FIG. 12, the distance measurement unit 1200 determines the distance between the base unit 102 and the remote unit 104 based on the phase difference between the locator pulses and the corresponding response pulses. The distance measurement unit 1200 includes a multiplier 1204 and a low-pass filter 1206.

The multiplier 1204 multiplies the notification signal generated by the receiver 208 with the signal used by the transmitter 204 to trigger generation of the locator pulses. The notification signal generated by the receiver 208 typically has a frequency that corresponds to the frequency of the signal used to trigger generation of the locator pulses. For example, where a 10 MHz signal is used to trigger generation of the locator pulses, the original 10 MHz signal is multiplied with the 10 MHz signal generated by the receiver 208.

The output of the multiplier 1204 is then fed to a low-pass filter 1206 that filters the received signal to produce a filtered signal. The filtered signal is a voltage that represents the phase difference between the two signals (the notification signal and the trigger signal). As the distance between the base unit 102 and the remote unit 104 increases from 0 m to 3 m, the phase may vary about 70 degrees.

The phase difference between the two signals is representative of the time taken for a locator pulse to travel from the base unit 102 to the remote unit 104 and for the corresponding return pulse to travel from the remote unit 104 to the base unit 102. Since the speed at which the pulses travel is known, the distance between the base unit 102 and the remote unit 104 can be determined.

However, the phase difference also includes the following: (i) the time for the base unit 102 to generate and transmit the locator pulse; (ii) the time for the remote unit 104 to receive and detect the locator pulse; (iii) the time for the remote unit 104 to generate and transmit a corresponding return pulse; and (iv) the time for the base unit 102 to receive and detect the return pulse. Typically the detection and generation time of each of the units is fixed.

To determine these fixed delays, the base and remote units 102 and 104 are preferably calibrated. During the calibration process the remote and base units 104 and 102 are set-up so that they have a known spatial relationship (e.g. the distance between them is known). In some embodiments, this involves plugging the remote unit 104 into the base unit 102 (via the communication port, for example). A test locator pulse is then sent from the base unit 102 to the remote unit 104 and a test return pulse is received and detected. The time to complete the exchange is equal to the fixed delays in the system plus the time for the test pulses to travel between the base and the remote. Since the distance between the base and remote units 102 and 104 is known, the fixed delays can be determined by subtracting the travel time from the measured time. Once the fixed delays are known, they can then be subtracted from the time calculated by the phase difference.

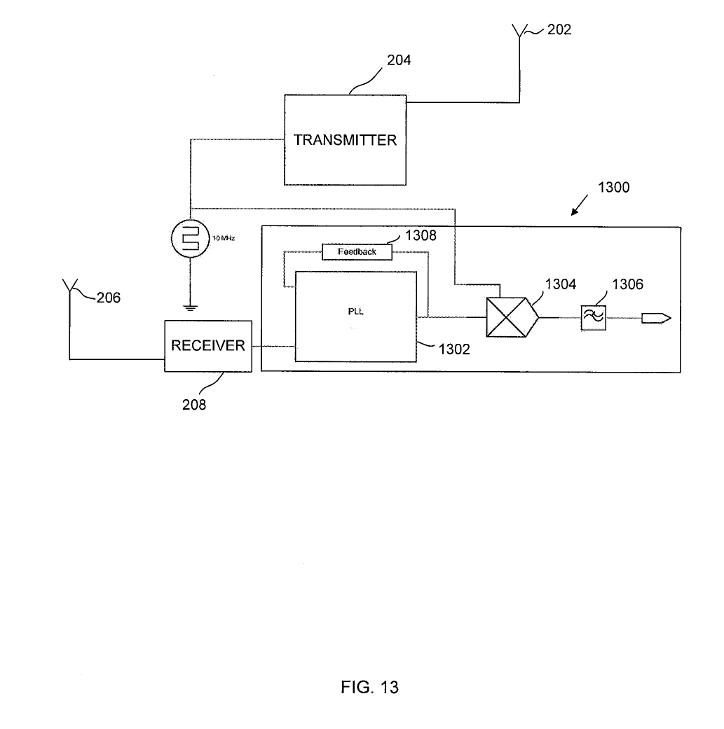

Reference is now made to FIG. 13, which illustrates a second embodiment 1300 of the distance measurement unit 210 of FIG. 2. The second embodiment 1300 of the distance measurement unit 210 is a variant of the first embodiment 1200 of FIG. 12. Specifically, similar to the distance measurement unit 1200 of FIG. 12, distance measurement unit 1300 determines the distance between the base unit 102 and the remote unit 104 based on the phase difference between the locator pulses and the corresponding response pulses. The distance measurement unit 1300, like distance measurement unit 1200 of FIG. 12, includes a multiplier 1304 and a low pass filter 1306. The difference between the distance measurement unit 1200 of FIG. 12 and the distance measurement unit 1300 is the addition of a phase-locked loop (PLL) 1302 and a feedback circuit 1308.

The phase-locked loop 1302 receives the notification pulses from the receiver 208 and locks onto the notification pulses. The output of the phase-locked loop 1302 is a signal that is in phase with the notification pulses (and thus the return pulses). For example, if a 10 MHz signal is used to trigger the generation of the locator pulses, the PLL 1302 will produce a 10 MHz clock signal that is in phase with the return pulses received from the remote unit 104. In a preferred embodiment, the phase-locked loop 1302 is a Type II PLL, which, as is known to those of skill in the art, is a PLL that has at least one integrator in the loop.

One advantage of using the PLL 1302 is that it will typically enable accurate recovery of the phase difference even when some of the return pulses are not detected by the receiver 208 or not received at all. For example, if the base unit 102 is not reliably receiving response pulses from the remote unit 104, this will cause the non-PLL embodiment (i.e. embodiment 1200 of FIG. 12) to determine the distance between the base unit 102 and the remote unit 104 to be greater than it is. Conversely, the PLL embodiment (i.e. embodiment 1300 of FIG. 13) will “smooth” out the notification signal received from the receiver 208 so an accurate distance can be calculated.

Another advantage of using the PLL 1302 is that it can clean up jitter introduced by the electronic components of the system. However, the PLL 1302 makes the circuit more complex.

In some cases, the detection and generation delay will not be precisely fixed. Therefore, a feedback circuit 1308 may be added to the PLL 1302 feedback loop to smooth out the slight variations in the detection and generation delays. In one embodiment, the feedback circuit 1308 includes a filter (not shown) designed to average a predetermined number of return pulses. The filter (not shown) may be implemented using analog or digital circuitry.

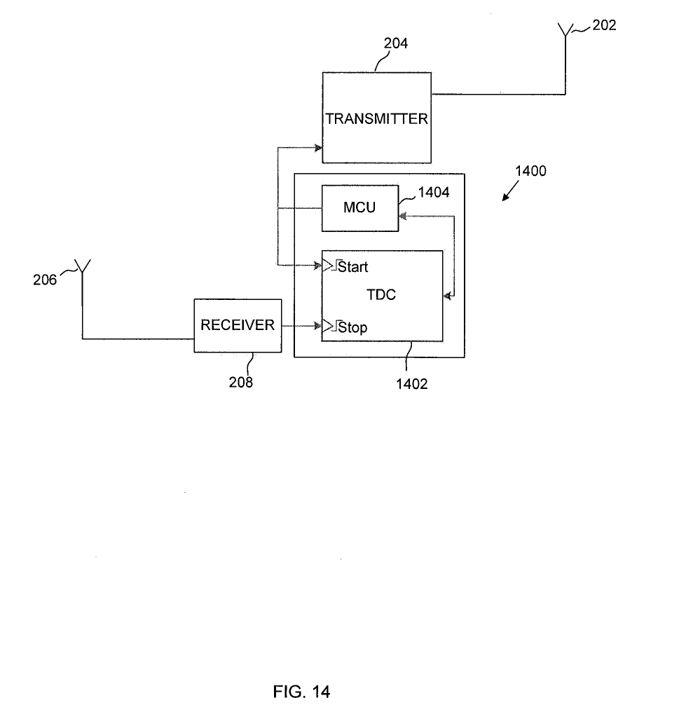

Reference is now made to FIG. 14, which illustrates a third embodiment 1400 of the distance measurement unit 210 of FIG. 2. As described above, the third embodiment 1400 of the distance measurement unit 210 determines the distance between the base unit 102 (and thus the person 106) and the remote unit 104 (and thus the object of value 108). In some cases, if the distance exceeds a predetermined threshold, the distance measurement unit 1400 activates the alarm unit 212. In the embodiment shown in FIG. 14, the distance measurement unit 1400 determines the distance between the base unit 102 and the remote unit 104 by measuring the time between sending a locator pulse and detecting the corresponding return pulse. The distance measurement unit 1400 includes a timer 1402 and a micro-controller 1404.

The timer 1402 is preferably a device, such as a time to digital converter (TDC) or a time to analog converter (TAC), that can measure or calculate the time between a start pulse and a stop pulse. Typically such timers can accurately measure short periods of time. For example, modern TDCs are accurate to 50 ps.

In the embodiment shown in FIG. 14, the timer 1402 receives two inputs: (i) the trigger signal used to trigger generation of the locator pulses; and (ii) the output of the receiver 208 (i.e. the notification pulses). The trigger signal is used as the start pulse and thus will start the clock running. The output of the receiver 208 (i.e. the notification pulses) is used as the stop pulse and thus will stop the clock running. Accordingly, the timer 1402 is started when a locator pulse is generated and is stopped when a corresponding return pulse is detected. The elapsed time is then communicated to the micro-controller 1404. In some embodiments, the micro-controller 1404 may read the elapsed time information from the timer 1402. In other embodiments, the timer 1402 actively provides or transmits the elapsed time to the micro-controller 1404.

In some embodiments, the micro-controller 1404 of FIG. 14 may be a central micro-controller that controls and interacts with various units (i.e. the receiver 208 and the distance measurement unit 210) of the base unit 102. For example, the micro-controller 1404 of FIG. 14 may be the same as micro-controller 1104 of FIG. 11. In other embodiments, the various units (i.e. the receiver 208 and the distance measurement unit 210) of the base unit 102 may have separate and distinct micro-controller units. For example, the micro-controller 1404 of FIG. 14 may be separate and distinct from the micro-controller 1104 of FIG. 11.

Once the micro-controller 1404 has received the elapsed time from the timer 1402, the micro-controller 1404 uses the elapsed time to determine the distance between the base unit 102 and the remote unit 104. Specifically, since the speed at which a pulse travels through air is known, once the time for a pulse (locator or return) to travel between the base unit 102 and the remote unit 104 is known, the micro-controller can determine the distance between the base unit 102 and the remote unit 104. However, the elapsed time includes more than just the time of flight of the pulses. Specifically, the elapsed time also includes the time for both the base unit 102 and the remote unit 104 to generate a pulse and detect a pulse. These times are typically static and thus can be determined through a calibration process and subtracted from the elapsed time.

In one embodiment, the calibration process involves directly connecting the remote unit 104 and the base unit 102 (e.g. via the communication port). A test locator pulse is then sent from the base unit 102 to the remote unit 104 and a corresponding return pulse is detected at the base unit. The time to complete this pulse exchange is equal to the fixed system delays. This delay time is loaded into the micro-controller 1404 and then subtracted from the elapsed time measured by the timer 1402.

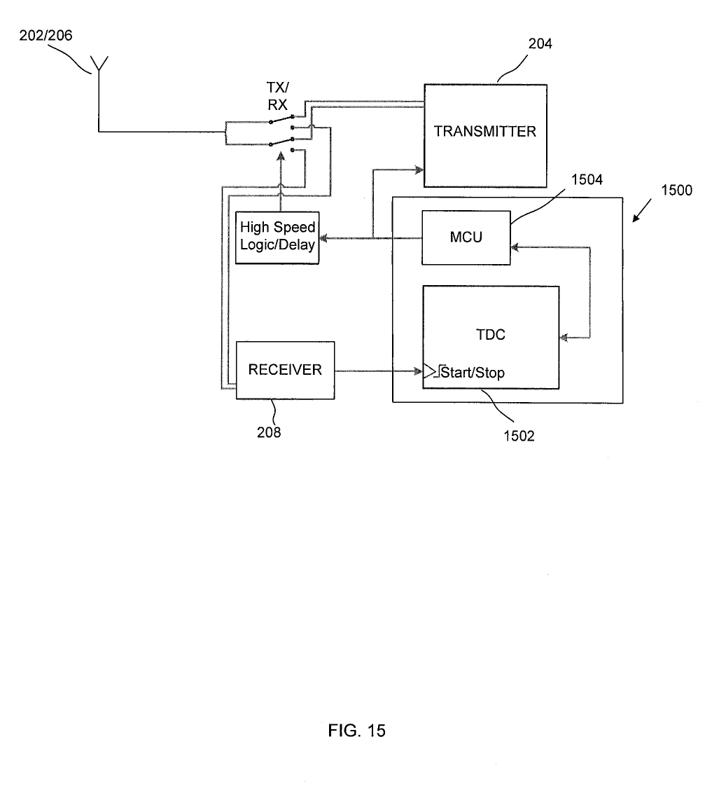

Reference is now made to FIG. 15, which illustrates a fourth embodiment 1500 of the distance measurement unit 210 of FIG. 2. The fourth embodiment 1500 of the distance measurement unit 210 is a variant of the third embodiment 1400 of FIG. 14. Specifically, similar to the distance measurement unit 1400 of FIG. 14, distance measurement unit 1500 determines the distance between the base unit 102 and the remote unit 104 by measuring the time between sending a locator pulse and receiving the corresponding return pulse. The distance measurement unit 1500, like distance measurement unit 1400 of FIG. 14, includes a timer 1502 and a micro-controller 1504. The difference between the distance measurement unit 1400 of FIG. 14 and the distance measurement unit 1500 are the techniques and signals used to start and stop the timer 1502. Specifically, the distance measurement unit 1400 of FIG. 14 uses the trigger signal used to trigger generation of the locator pulses as the timer 1402 start pulse, and the output of the receiver 208 (i.e. the notification pulses) as the timer 1402 stop pulse. In contrast, the distance measurement unit 1500 of FIG. 15 uses the output of the receiver 208 as the start and stop pulse.

The distance measurement unit 1500 of FIG. 15 works in conjunction with a single antenna that is switched via an RF switch between a transmit signal path and a receive signal path. Specifically, the distance measurement unit 1500 of FIG. 15 exploits a limitation of the RF switch to get a more accurate distance measurement. Most RF switches do not completely isolate the two signal paths. In particular, a portion of any signal transmitted on one signal path will be transmitted on the other path. For example, a portion of the locator pulse sent on the transmit signal path is typically transmitted on the receive signal path. Accordingly, the receiver 208 receives and detects a portion of the transmitted locator pulse and generates a corresponding notification pulse which is sent to the timer 1502. This notification pulse is used as the start pulse and thus starts the timer 1502.

When the corresponding return pulse is received by the antenna, it is detected by the receiver 208 which generates a corresponding pulse (i.e. notification pulse) that is sent to the timer 1502. This pulse is used as the stop pulse and thus stops the timer 1502.

The distance measurement unit 1500 of FIG. 15 will typically produce a more accurate distance measurement than the distance measurement unit 1400 of FIG. 14. This is because the elapsed time measurement generated in FIG. 15 includes fewer system delays. Although the times for the base and remote units 102 and 104 to generate a pulse and detect a pulse are generally fixed, they do tend to drift over time. Therefore if they can be eliminated from the calculation, the calculation may be more accurate.

Since the distance measurement unit 1500 of FIG. 15 has removed the time for the base unit 102 to generate a locator pulse, and the time for the base unit 102 to detect a return pulse from the elapsed time measured by the timer 1502, the distance measurement calculated by the micro-controller 1504 may be more accurate than the distance measurement calculated by the micro-controller 1404 of FIG. 14. Accordingly, in this embodiment, the only times that need to be removed from the elapsed time measured by the timer 1502, are the time it takes the remote unit 104 to detect a locator pulse, and the time it takes the remote unit 104 to generate and transmit a return pulse.

In some embodiments, the micro-controller 1504 of FIG. 15 may be a central micro-controller that controls and interacts with various units (i.e. the receiver 208 and the distance measurement unit 210) of the base unit 102. For example, the micro-controller 1504 of FIG. 15 may be the same as micro-controller 1104 of FIG. 11. In other embodiments, the various units (i.e. the receiver 208 and the distance measurement unit 210) of the base unit 102 may have separate and distinct micro-controller units. For example, the micro-controller 1504 of FIG. 15 may be separate and distinct from the micro-controller 1104 of FIG. 11.

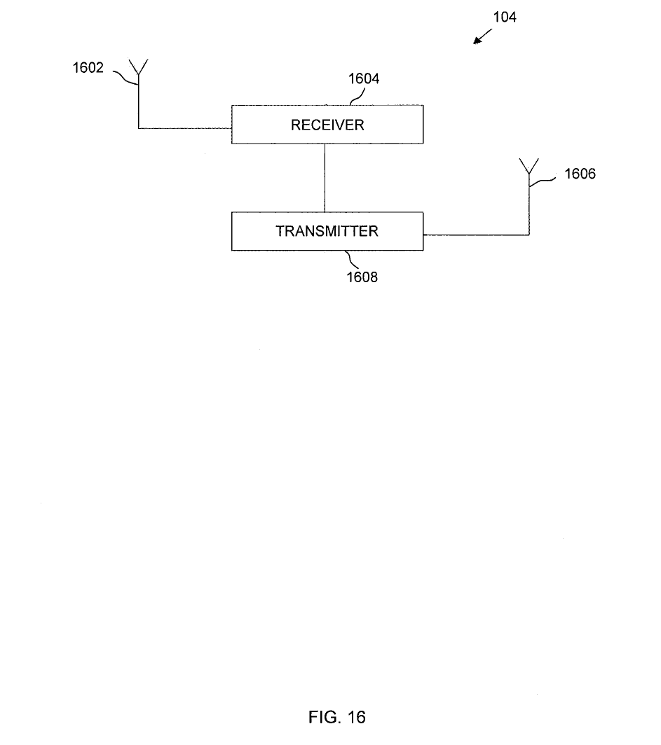

Reference is now made to FIG. 16, which illustrates a remote unit 104 in accordance with an embodiment. The remote unit 104 includes a receiver antenna 1602, a receiver 1604, a transmitter antenna 1606, and a transmitter 1608. The receiver antenna 1602 receives the locator pulses transmitted by the base unit 102 and provides the locator pulses to the receiver 1604. Once the receiver 1604 detects that a locator pulse has been received, the receiver notifies the transmitter 1606. In response to receiving notification from the receiver 1604 that a locator pulse has been received, the transmitter 1606 generates a corresponding return pulse and provides the return pulse to the transmitter antenna 1606. The transmitter antenna 1606 then transmits the return pulse to the base unit 102.

The receiver 1604 may be implemented in the same manner as the receiver 208 of the base unit 102. For example, the receiver 1604 may be implemented as receiver 208 of FIG. 11. Similarly, the transmitter 1608 may be implemented in the same manner as the transmitter 204 of the base unit 102. For example, the transmitter 1608 may be implemented as transmitter 400 of FIG. 4, transmitter 800 of FIG. 8, or transmitter 1000 of FIG. 10.

One concern with any battery-operated device is power consumption. In any RF transceiver circuit, it is typically the transmitter that consumes more power than the receiver. However, the transmitter can be deactivated or turned off until it is required to transmit. Accordingly, the greater concern is determining when to turn on and off the receiver unit. Since, even in power optimized designs, receivers can easily consume 330 to 400 mW of power at high frequencies, the receiver cannot be left on all the time without draining the battery.

To address this problem, the base unit 102 and the remote unit 104, each may include a timing circuit (not shown) that is used to control the activation and deactivation of the various components of the base unit 102 and the remote unit 104 respectively to reduce the power consumption. In one embodiment, the timing units use communication windows to determine when to activate and deactivate the corresponding receiver and transmitter.

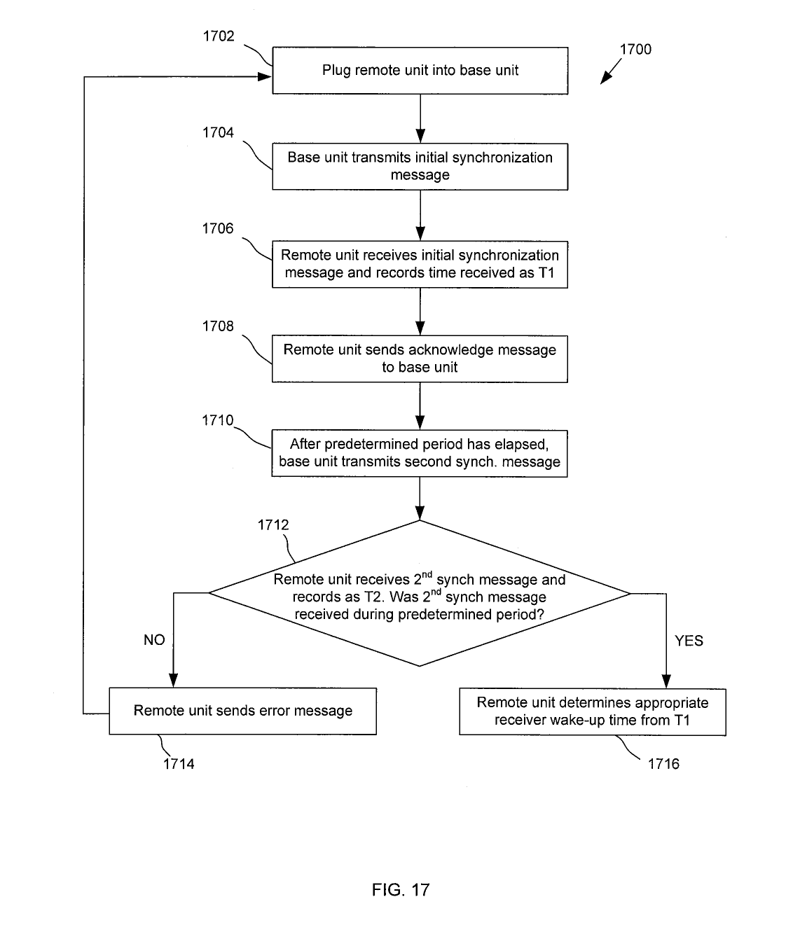

Specifically, the base unit 102 and the remote unit 104 may go through a synchronization procedure in which (i) their internal clocks are synchronized; and (2) they agree upon predetermined times and predetermined periods in which they will activate their respective transmitters and receivers. An exemplary synchronization procedure will be described with reference to FIG. 17. Once the synchronization procedure is complete, the timing circuit only activates the receiver and transmitter at the predetermined times for the predetermined periods. In one embodiment, the timing circuit only activates the receiver every 2¹⁵ ticks for 3 ticks.

The problem with this method, however, is that even with very accurate internal clocks, there will be enough drift over time that the clocks will get out of sync.

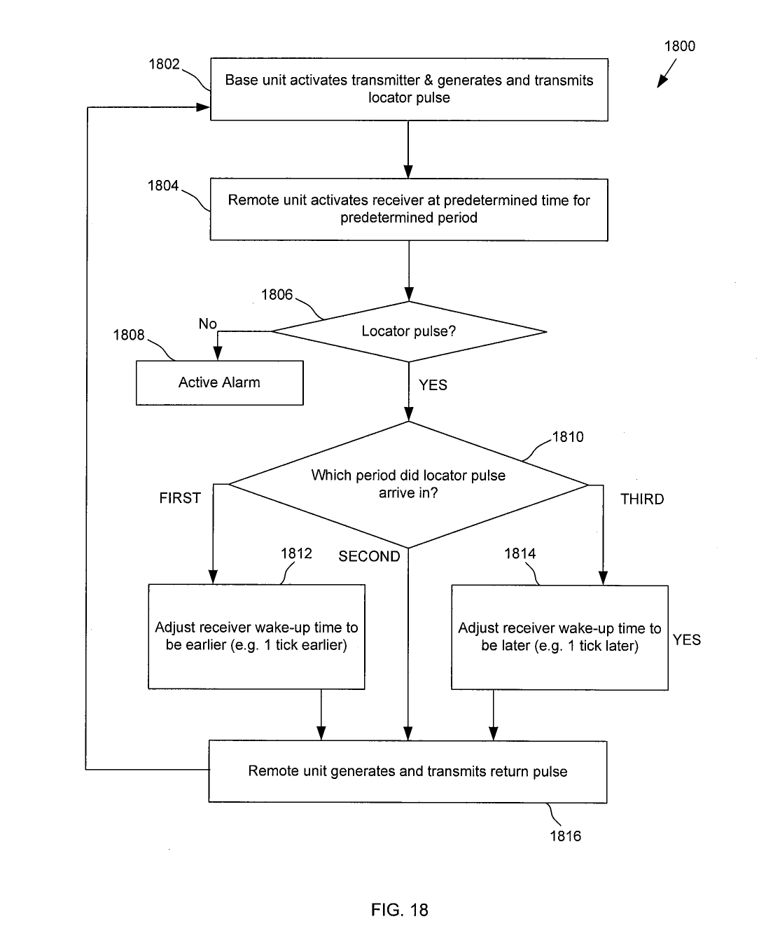

For example, low power watch crystals with 20 ppm accuracy can get out of sync by more than one second every two days. The problem can be resolved by implementing a clock drift correction procedure in addition to synchronization. In one embodiment, the remote unit 104 adjusts the activation time based on when within the predetermined period the remote unit 104 receives a locator pulse. For example, if the remote unit 104 receiver is activated for 3 ticks, the remote unit 104 timing circuit may adjust the wake up time based on when during those 3 ticks the locator pulse arrives. For example, in one embodiment, if the locator pulse arrives during the first tick, then the remote unit 104 may adjust the receiver wake up time to be 1 tick earlier, and if the locator pulse arrives during the third tick, then the remote unit 104 may adjust the wake up time to be 1 tick later. An exemplary clock drift correction procedure will be described with reference to FIG. 18.

Reference is now made to FIG. 17, which illustrates an exemplary synchronization procedure 1700 in accordance with an embodiment. At step 1702, the remote unit 104 is plugged into the base unit 102 (e.g. via the communication port). This activates the synchronization procedure. The method 1700 then proceeds to step 1704.

At step 1704, the base unit 102 transmits an initial synchronization message at a predetermined time to the remote unit 104. For example, in one embodiment, the base unit 102 transmits a real-time clock (RTC) tick to the remote unit 104.

In one embodiment, the base unit 102 maintains a counter that rolls over every second, for example. Typically, the counter counts from 0 to 32,767. In other embodiments, the counter may roll over every half second or every quarter second, for example. In these embodiments, when the counter reaches a predetermined number (e.g. zero) it will send an initial synchronization message (e.g. a real-time clock (RTC) tick) to the first remote unit 104. It uses another predetermined number (e.g. 8,192) for determining when to send an initial synchronization message to a second remote unit, another predetermined number (e.g. 16,384) for determining when to send an initial synchronization message to a third remote unit, and yet another predetermined number (e.g. 24,576) for determining when to send an initial synchronization message to a fourth remote unit, and so on. While the specific numbers associated with each remote unit are not particularly relevant, typically the numbers are generally evenly spaced apart between the beginning counter number and the ending counter number. By selecting a different number for each remote unit 104, the remote units 104 will communicate with the base unit 102 in a fashion that prevents collisions. Once the initial synchronization message is sent, the method 1700 proceeds to step 1706.

At step 1706, the remote unit 104 receives the initial synchronization message and records the time the message was received as T1. The method 1700 then proceeds to step 1708.

At step 1708, the remote unit 104 sends an acknowledge message to the base unit 102 to indicate that the initial synchronization message was successfully received. The method 1700 then proceeds to step 1710.

At step 1710, after a predetermined period of time has elapsed since the sending of the initial synchronization message, the base unit 102 generates and transmits a second synchronization message. In one embodiment, the second synchronization message includes a tick count. In one embodiment, the predetermined period is equal to 1024 ticks. The method then proceeds to decision diamond 1712.

At decision diamond 1712, the remote unit 104 receives the second synchronization message and records the time received as T2. The remote unit 104 then determines if the second synchronization message has been received within an allowed period of time. For example, in some embodiments, the remote unit 104 checks to see if the second synchronization message is received between 1023 and 1025 ticks from the initial or first synchronization message. If the second synchronization message has not been received within the allowed period of time, then the method proceeds to step 1714. If the second synchronization message has been received within the allowed period of time, then the method 1700 proceeds to step 1716.

At step 1714, the remote unit 104 sends an error message to the base unit. The method 1700, then returns to step 1702 where the synchronization is attempted again.

At step 1716, the remote unit 104 determines the appropriate wake up time for its receiver based on when it received the second synchronization message. For example, in one embodiment, if the difference between T2 and T1 is equal to 1023, then the receiver wake time is set to T1-2; if the difference between T2 and T1 is equal to 1024, then the receiver wake time is set to T1-1; and if the difference between T2 and T1 is equal to 1025 then the receiver wake time is set to T1. Once the receiver wake time has been established, the method 1700 ends.

Reference is now made to FIG. 18, which illustrates an exemplary clock drift correction procedure 1800 in accordance with an embodiment. At step 1802, the base unit 102 activates the transmitter 204 at the predetermined time and generates and transmits a locator pulse to the remote unit 104. The method 1800 then proceeds to step 1804.

At step 1804, the remote unit 104 activates its receiver a predetermined amount of time before the scheduled time and for a predetermined period. After the predetermined period has expired, the remote unit 104 deactivates the receiver. In one embodiment, the remote unit 104 activates its receiver 1.5 ticks prior to the predetermined time and keeps it active for 3 ticks. The method 1800 then proceeds to decision diamond 1806.

At decision diamond 1806, after the predetermined period (i.e. 3 ticks) has expired, the remote unit 104 determines whether it has received a locator pulse. If the remote unit 104 has not received a locator pulse, then the method 1800 proceeds to step 1808. If the remote unit 104 has received a locator pulse then the method 1800 proceeds to decision diamond 1810.

At step 1808, the remote unit 104 determines that it has exceeded the predetermined distance, or the base unit 102 has lost power, and activates the alarm unit 212. The method 1800 then ends here.

At decision diamond 1810, the remote unit 104 determines whether the locator pulse was received during the first portion of the predetermined period, the second portion of the predetermined period, or the third portion of the predetermined period. In one embodiment the predetermined period is three ticks and the three ticks are divided into three equal portions of 1 tick each. If the locator pulse arrived during the first portion of the predetermined period (i.e. during the first tick) the method 1800 proceeds to step 1812. If the locator pulse arrived during the third portion of the predetermined period (i.e. during the third tick), the method 1800 proceeds to step 1814. If the locator pulse arrived during the second portion of the predetermined period (i.e. during the second tick), the method proceeds to 1816.

At step 1812, if the locator pulse arrived during the first portion of the predetermined period (i.e. during the first tick), the remote unit 104 determines that the base unit 102 internal clock is running slightly faster than its own internal clock and to compensate for the drift, the remote unit 104 schedules the next wake up time to be earlier than the predetermined time. For example, in one embodiment, the remote unit 104 adjusts the receiver wake up time to be 1 tick earlier. Once the receiver wake up time has been adjusted, the method 1800 proceeds to step 1816.

At step 1814, if the locator pulse arrived during the third portion of the predetermined period (i.e. during the third tick), the remote unit 104 determines that the base unit 102 internal clock is running slightly slower than its own internal clock and to compensate for the drift, the remote unit 104 schedules the next wake up time to be later than the predetermined time. For example, in one embodiment, the remote unit 104 adjusts the receiver wake up time to be 1 tick later. Once the receiver wake up time has been adjusted, the method 1800 proceeds to step 1816.

At step 1816, the remote unit 104 generates and transmits a corresponding return pulse. The method 1800 then returns to step 1802. While step 1816 is shown in FIG. 18 as following directly from step 1814, in other embodiments, step 1816 may occur directly after step 1806 or 1808. In these embodiments, the remote unit 104 automatically generates the corresponding return pulse before the remote unit 104 has analyzed the locator pulse.

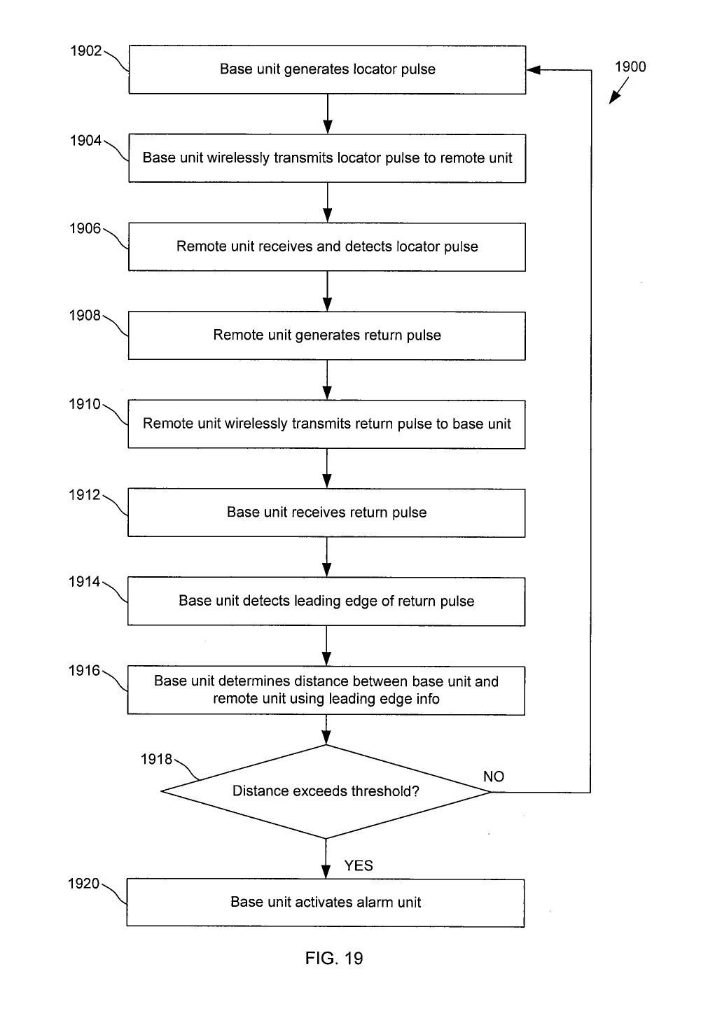

Reference is now made to FIG. 19, which illustrates a method of determining the distance between two objects in accordance with an embodiment. In this exemplary method, the base unit 102 is attached to the first object (i.e. person 106), and the remote unit 104 is attached to the second object (i.e. object of value 108). At step 1902, the base unit generates one or more locator pulses. Preferably, the locator pulses are shaped to reduce the effect of multipath reflections as discussed above. Specifically, the one or more locator pulses are preferably high bandwidth, short duration pulses. In some embodiments, the locator pulses are generated by combining a carrier signal (i.e. a sinusoidal signal, such as a sine signal), with a modulation signal (i.e. a rectangle signal, a sinc signal, a Gaussian signal, etc.). The locator pulses may be generated by a transmitter unit, such as transmitter 400 of FIG. 4, transmitter 800 of FIG. 8, or transmitter 1000 of FIG. 10. Once the one or more locator pulses have been generated, the method 1900 proceeds to step 1904.

At step 1904, the base unit 102 wirelessly transmits the one or more locator pulses to the remote unit 104. This preferably involves providing the one or more locator pulses to an antenna which converts the one or more locator pulses into electromagnetic waves. Once the one or more locator pulses have been transmitted, the method 1900 proceeds to step 1906.

At step 1906, the remote unit 104 receives the one or more locator pulses transmitted by the base unit 102. The remote unit 104 preferably has an antenna that receives the electromagnetic waves generated by the base unit 102 and converts them into electrical signals. The electrical signals are then provided to a receiver unit, such as receiver 208 of FIG. 11, which identifies the received signal as a locator pulse. Once the remote unit has received and identified one or more locator pulses, the method proceeds to step 1908.

At step 1908, the remote unit 104 generates one or more return pulses in response to the one or more locator pulses. Typically the remote unit 104 will generate one return pulse for each locator pulse received. The return pulses preferably have the same characteristics as the locator pulses. Specifically, the return pulses are preferably high bandwidth and short duration. The return pulses are also generated in a similar manner to the locator pulses. For example, the return pulses may be generated by combining a carrier signal (e.g. a sinusoidal signal, such as a sine signal) with a modulation signal (e.g. a rectangle signal, a sinc signal, a Gaussian signal etc.). The return pulses may be generated by a transmitter unit, such as transmitter 400 of FIG. 4, transmitter 800 of FIG. 8, or transmitter 1000 of FIG. 10. Once the one or more return pulses have been generated, the method 1900 proceeds to step 1910.

At step 1910, the remote unit 104 wirelessly transmits the one or more return pulses to the base unit 102. This preferably involves providing the one or more return pulses to an antenna which converts the one or more return pulses into electromagnetic waves. The antenna may be the same as or different from the antenna used to receive the locator pulses. Once the one or more return pulses have been transmitted, the method 1900 proceeds to step 1912.

At step 1912, the base unit 102 receives the one or more return pulses transmitted by the remote unit 104. The base unit 102 preferably has an antenna that receives the electromagnetic waves generated by the remote unit and converts them into electrical signals. The antenna may be the same as or different from the antenna used to transmit the locator pulses. Once the one or more return pulses have been received, the method 1900 proceeds to step 1914.

At step 1914, the base unit 102 receives the one or more return pulses from the antenna and monitors the return pulses to detect the leading edges. In one embodiment, detecting the leading edge of the return pulses involves monitoring the amplitude of the return pulses and detecting a leading edge when the amplitude of the return pulses exceeds a predetermined threshold. The leading edge detection may be implemented using a receiver unit, such as receiver 208 of FIG. 11. Once the leading edges have been detected, the method 1900 proceeds to step 1916.

At step 1916, the base unit 102 uses the leading edge information to calculate the distance between the base unit and the remote unit. In one embodiment, the base unit calculates the distance between the base unit and the remote unit by measuring the phase difference between the locator pulses and the return pulses. In another embodiment, the base unit calculates the distance between the base unit and the remote unit by measuring the time of flight of the return pulse. The distance calculation may be performed by a distance measurement unit, such as distance measurement unit 1200 of FIG. 12, distance measurement unit 1300 of FIG. 13, distance measurement unit 1400 of FIG. 14, or distance measurement unit 1500 of FIG. 15. In some embodiments, after the distance has been calculated, the method returns to step 1902 to repeat the method. In other embodiments, the method proceeds to decision diamond 1918.

At decision diamond 1918, the base unit 102 compares the distance calculated in step 1916 against a predetermined distance or threshold to determine if the distance has exceeded the predetermined distance or threshold. If the predetermined distance or threshold has not been exceeded then the method 1900 returns to step 1902 to repeat the method. If, however, the predetermined distance has been exceeded, the method 1900 proceeds to step 1920.

At step 1920, the base unit 102 activates an alarm or alert. The alarm or alert may be visual or audio or any other type of alert. In some embodiments, the alarm or alert is associated with the base unit 102. In some embodiments, the alarm or alert is associated with the remote unit 104. In other embodiments, the alarm or alert is associated with both the base and remote units 102 and 104. After this step is complete, the method 1900 ends.

The systems and methods described herein preferably produce a distance measurement that is accurate to within 50 cm, and in some cases 10 cm, when the base unit 102 and the remote unit are within 3 m of each other.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A detection system comprising:
a base unit, the base unit comprising:
a first transmitter for transmitting at least one locator pulse; and
a first receiver for receiving at least one return pulse, the first receiver comprising a pulse detector for detecting the leading edge of the at least one return pulse; and
a distance measurement unit; and
a remote unit, the remote unit comprising:
a second receiver for receiving the at least one locator pulse; and
a second transmitter for transmitting the at least one return pulse in response to the at least one locator pulse;
wherein the distance measurement unit is adapted for determining the distance between the base unit and the remote unit based on the leading edge of the at least one return pulse.

2. The detection system of claim 1, wherein at least one of the base unit and the remote unit further comprises an alarm unit and the distance measurement unit activates the alarm unit when the distance exceeds a predetermined threshold.

3. The detection system of claim 1, wherein the distance measurement unit determines the distance between the base unit and the remote unit by measuring the phase difference between the at least one locator pulse and the at least one return pulse.

4. The detection system of claim 3, wherein the distance measurement unit comprises a multiplier for combining a trigger signal and a notification signal to produce the phase difference, wherein the trigger signal is related to the at least one locator pulse and the notification signal is related to the at least one return pulse.

5. The detection system of claim 4, wherein the distance measurement unit further comprises a phase-locked loop for locking onto the notification signal.

6. The detection system of claim 1, wherein the distance measurement unit determines the distance between the base unit and the remote unit by measuring the time of flight of the at least one return pulse.

7. The detection system of claim 6, wherein the distance measurement unit comprises:
a timer for measuring the time between sending the at least one locator pulse and detecting the leading edge of the corresponding at least one return pulse.

8. The detection system of claim 7, wherein the timer is at least one of a time to digital converter and a time to analog converter.

9. The detection system of claim 1, wherein the at least one locator pulse and the at least one return pulse are shaped to reduce the effect of multipath reflections.

10. The detection system of claim 9, wherein the first transmitter generates the at least one locator pulse by combining a carrier signal and a modulation signal.

11. The detection system of claim 10, wherein the first transmitter comprises:
a high frequency oscillator for generating the carrier signal;
a modulation signal generator for generating the modulation signal; and
a multiplier for combining the carrier signal and the modulation signal to produce the at least one locator pulse.

12. The detection system of claim 11, wherein the modulation signal is selected from one of the group comprising: a rectangle wave signal, a sinc signal, a Gaussian signal, and a Gaussian derivative signal.

13. The detection system of claim 11, wherein the modulation signal generator is a digital to analog converter.

14. The method of claim 9, wherein the first transmitter generates the at least one locator pulse using a step recovery diode technique.

15. The detection system of claim 9, wherein multipath reflections caused by a far object have substantially no effect on the at least one locator pulse and the at least one return pulse, wherein a far object is an object that satisfies the following equation:
x₁+x₂−>c·t_{c}
where x₁ is the distance between the object and the base unit, x₂ is the distance between the object and the remote unit, d is the distance between the base unit and the remote unit, c is the speed of light, and t_{c} is the width of the at least one locator pulse.

16. The detection system of claim 1, wherein the first receiver comprises a level detector for detecting the leading edge of the at least one return pulse.

17. The detection system of claim 16, wherein the first receiver further comprises gain adjustment circuitry to automatically adjust the gain of the at least one return pulse based on the strength of the at least one return pulse.

18. The detection system of claim 1, wherein:
the base unit further comprises a first timer, the first timer operable to activate the first transmitter at a first predetermined time for a first predetermined period, and the first receiver at a second predetermined time for a second predetermined period; and
the remote unit further comprises a second timer, the second timer operable to activate the second receiver at a third predetermined time for a third predetermined period, and the second transmitter at a fourth predetermined time for a fourth predetermined period.

19. The detection system of claim 18, wherein the second timer adjusts the third predetermined time based on when during the third predetermined period the locator pulse is received at the remote unit.

20. The detection system of claim 19, wherein if the locator pulse is received in a first portion of the third predetermined period the second timer reduces the third predetermined time, and if the locator pulse is received in a last portion of the third predetermined period the second timer increases the third predetermined time.

21. The detection system of claim 18, wherein the base unit further comprises a communication port which is adapted to receive the remote unit and when the remote unit is inserted in the communication port, the base unit and remote unit engage in a synchronization process, wherein the synchronization process comprises establishing the predetermined times and periods.

22. A method for determining the distance between a base unit and a remote unit, the method comprising:
generating at least one locator pulse;
wirelessly transmitting the at least one locator pulse from the base unit to the remote unit;
receiving the at least one locator pulse at the remote unit;
generating at least one return pulse in response to the at least one locator pulse;
wirelessly transmitting the at least one return pulse from the remote unit to the base unit;
receiving the at least one return pulse at the base unit;
detecting the leading edge of the at least one return pulse; and
calculating the distance between the base unit and the remote unit based on the leading edge of the at least one return pulse.

23. The method of claim 22, further comprising activating an alarm when the distance between the base unit and the remote unit exceeds a predetermined threshold.

24. The method of claim 22, wherein calculating the distance between the base unit and the remote unit comprises measuring the phase difference between the at least one locator pulse and the at least one return pulse.

25. The method of claim 22, wherein calculating the distance between the base unit and the remote unit comprises measuring the time of flight of the at least one return pulse.

26. The method of claim 22, wherein the at least one locator pulse and the at least one return pulse are shaped to reduce the effect of multipath reflections.

27. The method of claim 26, wherein generating the at least one locator pulse comprises combining a carrier signal and a modulation signal.

28. The method of claim 27, wherein the carrier signal is a sinusoidal signal, and the modulation signal is selected from one of the group comprising a rectangle wave signal, a sinc signal, a Gaussian signal, and a Gaussian derivative signal.

29. The method of claim 26, wherein the at least one locator pulse is generated using a step recovery diode technique.

30. The method of claim 26, wherein multipath reflections caused by a far object have substantially no effect on the at least one locator pulse and the at least one return pulse, wherein a far object is an object that satisfies the following equation:
x₁+x₂−d>c*t_{c}
where x₁ is the distance between the object and the base unit, x₂ is the distance between the object and the remote unit, d is the distance between the base unit and the remote unit, c is the speed of light, and t_{c} is the width of the at least one locator pulse.

31. The method of claim 22, wherein detecting the leading edge of the at least one return pulse comprises measuring the level of the at least one return pulse.

32. The method of claim 31, wherein detecting the leading edge of the at least one return pulse further comprises automatically adjusting the gain of the return pulse based on the strength of the return pulse.

33. The method of claim 22, further comprising:
activating the base unit at a first predetermined time for a first predetermined period to transmit the at least one locator pulse;
activating the base unit at a second predetermined time for a second predetermined period to receive the at least one return pulse;
activating the remote unit at a third predetermined time for a third predetermined period to receive the at least one locator pulse; and
activating the remote unit at a fourth predetermined time for a fourth predetermined period to transmit the at least one return pulse.

34. The method of claim 33, further comprising adjusting the third predetermined time based on when during the third predetermined period the at least one locator pulse is received at the remote unit.

35. The method of claim 34, wherein adjusting the third predetermined time comprises increasing the third predetermined time if the locator pulse is received in a first portion of the third predetermined period, and decreasing the third predetermined time if the locator pulse is received in a last portion of the third predetermined period.

36. The method of claim 33, further comprising synchronizing the base unit and the remote unit, wherein synchronizing comprises establishing the predetermined times and periods.
